(19) United States
(12) Patent Application Publication
(10) Pub. No.: US 2024/0311862 A1
(43) Pub. Date: Sep. 19, 2024

(54) METHODS AND SYSTEMS FOR OBJECT-BASED USER RECOGNITION

(71) Applicant: Loop Commerce, Inc., Stamford, CT (US)

(72) Inventor: Gabriel Saunkeah, Stamford, CT (US)

(21) Appl. No.: 18/607,670

(22) Filed: Mar. 18, 2024

Related U.S. Application Data
(60) Provisional application No. 63/490,780, filed on Mar. 17, 2023.

(51) Int. Cl. G06Q 30/0217; G06Q 10/0639; G06Q 30/0601

(52) U.S. Cl. CPC G06Q 30/0217; G06Q 10/0639; G06Q 30/0643

(57) ABSTRACT

Systems and methods for providing object based recognition. A recognition system may provide a recognition initiation request to a gifting service system. The gifting service system may provide gift option information in response to the request and receive gift selection information in return. Based at least in part on the gift selection information, gift options may be provided to an intended recognition recipient. The recognition recipient may provide redemption information, which may initiate a recognition redemption action set.

### CROSS-REFERENCE TO RELATED APPLICATIONS

The present application claims the priority benefit of U.S. Provisional Patent Application No. 62/490,780 filed on Mar. 17, 2023 and titled “METHODS AND SYSTEMS FOR OBJECT-BASED USER RECOGNITION”, the disclosure of which is hereby incorporated by reference in its entirety for all purposes.

### FIELD

The present disclosure relates to systems and methods for providing object-based user recognition based at least in part on algorithmic assessment of users.

### SUMMARY

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment”, one or more embodiments, or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 shows an illustrative example of an environment in which a recognition recipient interacts with a recognition system, information is obtained from the recognition system and the recognition recipient, and a reward is delivered in accordance with at least one embodiment;

FIG. 2 shows an illustrative example of a process for providing recognition awards to recognition recipients in accordance with at least one embodiment;

FIG. 3 shows an illustrative example of a user interface element for allowing a recognizing entity to make various selections related to providing recognition to a recognition recipient according to at least one embodiment;

FIG. 4 shows an illustrative example of a user interface element for allowing a recognizing entity to make various selections related to providing recognition to a recognition recipient according to at least one embodiment;

FIG. 5 shows an illustrative example of a user interface element for allowing a recognizing entity to make various selections related to providing recognition to a recognition recipient according to at least one embodiment;

FIG. 6 shows an illustrative example of a user interface element for allowing a recognizing entity to make various selections related to providing recognition to a recognition recipient according to at least one embodiment;

FIG. 7 shows an illustrative example of a user interface element for allowing a recognizing entity to make various selections related to providing recognition to a recognition recipient according to at least one embodiment;

FIG. 8 shows an illustrative example of a user interface element for allowing a recognizing entity to make various selections related to providing recognition to a recognition recipient according to at least one embodiment;

FIG. 9 shows an illustrative example of a user interface element for allowing a recognizing entity to make various selections related to providing recognition to a recognition recipient according to at least one embodiment;

FIG. 10 shows an illustrative example of a user interface element for allowing a recognizing entity to make various selections related to providing recognition to a recognition recipient according to at least one embodiment;

FIG. 11 shows an illustrative example of a user interface element for allowing a recognizing entity to make various selections related to providing recognition to a recognition recipient according to at least one embodiment;

FIG. 12 shows an illustrative example of a user interface element for allowing a recognizing entity to make various selections related to providing recognition to a recognition recipient according to at least one embodiment;

FIG. 13 shows an illustrative example of a user interface element for allowing a recognizing entity to make various selections related to providing recognition to a recognition recipient according to at least one embodiment;

FIG. 14 shows an illustrative example of a user interface element for allowing a recognizing entity to make various selections related to providing recognition to a recognition recipient according to at least one embodiment;

FIG. 15 shows an illustrative example of a user interface element for allowing a recognizing entity to make various selections related to providing recognition to a recognition recipient according to at least one embodiment;

FIG. 16 shows an illustrative example of a user interface element for allowing a recognizing entity to make various selections related to providing recognition to a recognition recipient according to at least one embodiment;

FIG. 17 shows an illustrative example of a user interface element for allowing a recognizing entity to make various selections related to providing recognition to a recognition recipient according to at least one embodiment;

FIG. 18 shows an illustrative example of a user interface element for allowing a recognizing entity to make various selections related to providing recognition to a recognition recipient according to at least one embodiment;

FIG. 19 shows an illustrative example of a series of user interface elements for a recognition recipient to engage in a recognition award redemption process according to at least one embodiment;

FIG. 20 shows an illustrative example of a series of user interface element s for a recognition recipient to engage in a recognition award redemption process according to at least one embodiment;

FIG. 21 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Often, entities (e.g., employers, retailers, service providers, etc.) may desire to provide recognition to other entities (e.g., employees, customers, etc.). Such recognition may be provided, for example, to recognize an aspect of the behavior of the entity being recognized (e.g., a recognition recipient), such as, for example, service as an employee that exceeds expectations. In one or more embodiments, providing such recognition may encourage additional instances of the behavior being so recognized.

Embodiments disclosed herein may provide a framework for determining whether to provide recognition to a user (e.g., a recognition recipient) based on various criteria, and for determining what one or more gift options to present to a user being so recognized. Through this framework, a recognizing entity (e.g., an employer, a retailer, etc.) may interact with a gifting service system using a recognition system of the entity. Via the interaction, the recognizing entity may provide a recognition recipient identity, recognition quantity information (e.g., a number of points, stars, etc. being provided as recognition to the recognition recipient to quantify the recognition amount), other details related the recognition recipient and/or the recognizing entity, and/or any other information related to the recognition being provided (e.g., a reason and/or type of recognition). The obtained information may be used to determine one or more gift options to present to the recognizing entity, which may respond with additional information related to the gift options (e.g., a selection of one or more gifts or gift categories). One or more gift options may then be presented to the intended recognition recipient. In response to the gift options, the recognition recipient may provide various types of redemption information (e.g., gift selection, customization options, contact information, etc.), which may be used to perform a recognition redemption action (e.g., delivering the gift).

Recognition systems are often used by recognizing entities (e.g., employers) to reward recognition recipients (e.g., employees) in recognition of actions performed by the recognition recipients (e.g., performing above expectations for working duties). Such rewards are often provided by way of awarding the recognition recipient with a quantity of alternate value units, such as, for example, stars, points, etc. A recognition system may provide an interface through which a recognizing entity may select a recognition recipient to recognize, a recognition amount (e.g., fifty recognition stars), and/or other information related to the recognition (e.g., a reason, such as recognition for being a ‘team player’). A recognition system may also provide a user interface (UI) through which the recognition recipient may redeem the alternate value units, in whole, in part, or in combination with previously received alternate value units to obtain various items (e.g., goods, services, gift cards, etc.). Options provided for items that may be obtained by a recognition recipient are often common to all recognition recipients (e.g., not tailored to any specific recognition recipient), which may, for example, reduce the effectiveness of the recognition that a recognizing entity is attempting to provide to the recognition recipient.

In one or more embodiments, the effectiveness of the recognition that a recognizing entity is attempting to provide to the recognition recipient maybe improved by a gifting service system. A gifting service system may be a system for providing one or more gift options to a recognition recipient that are more specific to the recognition recipient, the reason for the recognition, a level of recognition (e.g., the amount of the recognition award value), and/or various other factors (e.g., time of year, location of recognition recipient, demographics of the recognition recipient, etc.). Such information may be obtained prior to the recognition, and/or obtained dynamically in real-time. As an example, the gifting service system may embed a user interface (e.g., a ‘gifting wizard’) into the recognition system that allows a recognizing entity to provide various items of information to the gifting service system, such as an identification of the recognition recipient, the amount of the recognition award, various information about the recognition recipient known to the recognizing entity, etc. Additionally or alternatively, information may be obtained from other sources. As an example, the recognition system and/or the gifting service system may maintain recognition recipient user information (e.g., in user profiles), which may be updated dynamically in real-time as more information is gained corresponding to a recognition recipient (e.g., actions performed (e.g., employee work actions), interactions with the recognition system and/or gifting service system, social media information, etc.).

Collectively, the aforementioned information (which may be referred to as user information) may be used by the gifting service system to generate any number of gift options (e.g., via a gift options algorithm). Information related to such gift options may be provided to the recognition system. Examples of such gift options information may include, but is not limited to: a curated selection (e.g., based on information corresponding to the recognition recipient, such as user profile information, demographics, geographic location, etc.) of possible gifts within the value amount being awarded, a set of gift categories, one or more gift options based on a type of recognition (e.g., certain ‘team’ related gifts for an employee being rewarded for being a ‘team player’), one or more gift categories, etc.

In response to the gift options information, a recognizing entity may interact with the embedded user interface of the gifting service system from within the recognition system to make one or more selections (e.g., select a gift category, select a particular gift, select a set of multiple gift options, etc.). Such selections may be provided to the gifting service system as gift selection information.

In one or more embodiments, the gifting service system responds to receipt of the gift selection information by providing gift options to the recognition recipient. Such gift options may include the one or more gifts selected by the recognizing entity, a set of gifts from a gift category selected by the recognizing entity, any number of additional gift options that may be redeemed instead of any gifts selected by the recognizing entity, and/or any number of alternate gift redemption options (e.g., an option to regift one or more of the gift selections, an option to donate the value of the recognition award, an option to add the value of the recognition award to a value store amount (e.g., bank the awarded stars)). The gift options may also include requests for other items of information. As an example, if a particular good is selected by a recognition recipient, a request may be made for information related to shipping the good to the recognition recipient, various customization options (e.g., size, color, etc.) etc. As another example, if a service is selected by the recognition recipient, a request may be made for information related to a communication channel to be used to communicate information to be used when redeeming the service (e.g., an email address to send a digital gift card to). As another example, if a recognition recipient elects to donate the value of the recognition award to charity, an identification of one or more charities may be requested. As another example, if a recognition recipient elects to regift a gift, information related to the intended regift recipient may be requested.

In one or more embodiments, the collective set of gift selections and other information may be referred to as redemption information, which may be provided from a recognition recipient device to the gifting service system. In response to receiving the redemption information, the gifting service system may perform a recognition redemption action set (e.g., deliver the gift to the recognition recipient, donate the value of the award amount to one or more selected charities, begin a gift redemption process with a selected regift recipient, add the award amount to a value store maintained by the recognition system for the recognition recipient, etc.).

In one or more embodiments, providing recognition systems with an ability to more specifically recognize accomplishments, achievements, actions, etc. of recognition recipients with certain gift options based at least in part on the recognition recipient, the reason for the reward, the amount of the award, etc. may allow the recognizing entity to provide better recognition to a recognition recipient. Such better recognition may, for example, encourage the recognition recipient to continue to perform in a manner that garners additional recognition in the future.

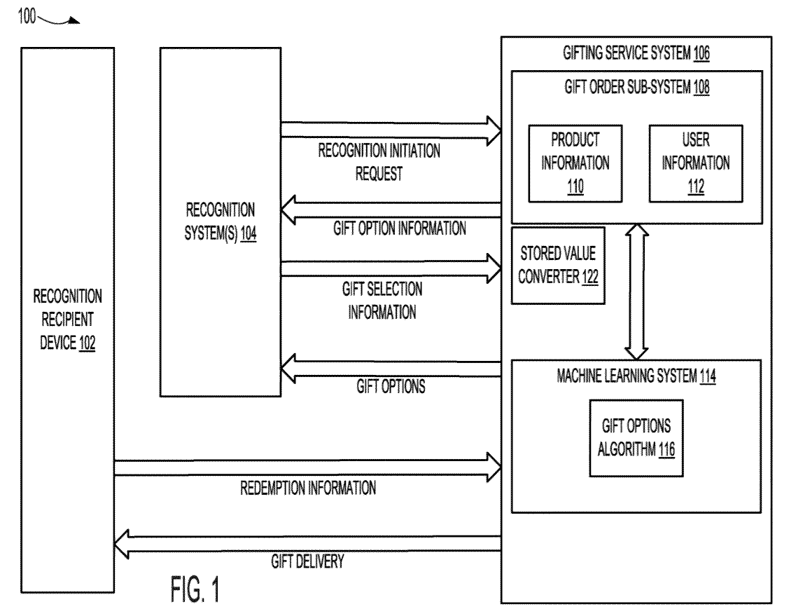

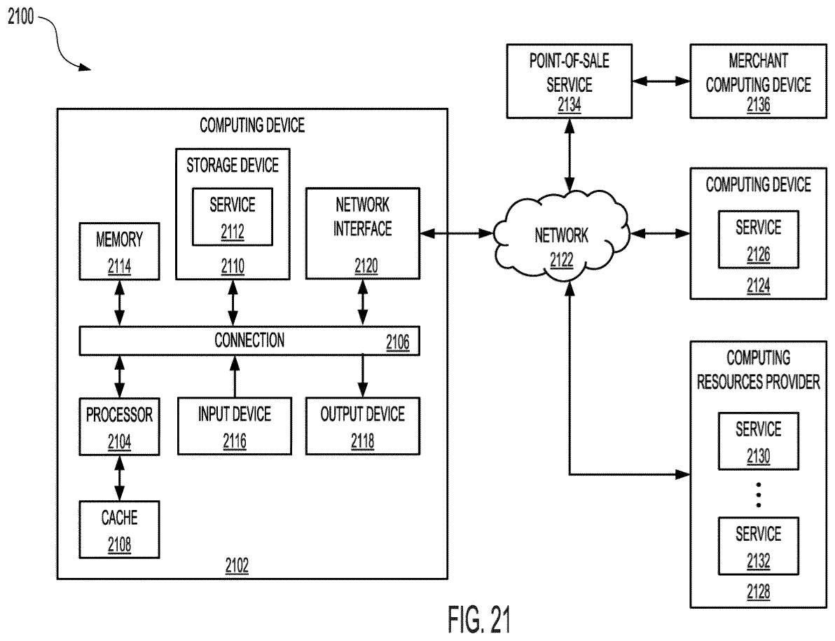

FIG. 1 shows an illustrative example of an environment 100 in which a recognition recipient device 102 interacts with a recognition system 104. The recognition recipient device 102 may be a computing device such as the computing device 2102 described herein at least in connection with FIG. 21. The computing device may be, for example, a laptop computer, a desktop computer, a smartphone, a tablet, a smart watch, or any other type of computing device such as those described herein. As another example, a recognition recipient, via the recognition recipient device 102 may interact with a recognition system 104 using a mobile application, web browser, etc. to access a recognition platform (e.g., a platform for providing recognition rewards to recognition recipients (e.g., employees) exhibiting certain traits, performing certain actions, etc. for which an employer desires to provide recognition in the form of a reward). In one or more embodiments, the recognition recipient device 102 communicates with the recognition system 104 over a network (not shown) such as the network 2122 described herein at least in connection with FIG. 21.

The recognition system 104 may be one or more computing devices such as the computing device 2102 described herein at least in connection with FIG. 21. As an example, the recognition system 104 may be one or more server computing devices controlled or otherwise used by a recognizing entity (not shown) interested in providing recognition to a recognition recipient for services rendered (e.g., in the course of employment) and/or activities performed. In one or more embodiments, a recognizing entity is any entity that engages in any activity that involves potential recognition recipients that perform services, actions, etc. for the recognizing entity for which a recognition award for such services, actions, etc. may be awarded by the recognizing entity. As an example, the recognizing entity may maintain a recognition system 104 that includes a user interface (UI) through which a recognizing entity (e.g., an employer) may provide recognition awards (e.g., in the form of starts, points, etc.) to a recognition recipient (e.g., an employee, contractor, customer, etc.), which may be redeemed by the recognition recipient using another portion of the recognition UI of the recognition system 104.

As an example, a recognition recipient, via the recognition recipient device 102, may interact with a recognition system 104 using a browser application (not shown) or other application (not shown). Such an interaction may, for example, access a user interface of the recognition system 104 that provides information related to a recognition rewards platform implemented by a recognizing entity. Such a user interface may include, but is not limited to, notifications of received recognition rewards (e.g., points, stars, dollar amounts, etc.), an aggregate total of accumulated recognition rewards, a user interface element allowing access to a marketplace where recognition rewards may be redeemed.

In one or more embodiments, while the recognition recipient accesses various webpages, online account management portals, or other channels that are providing information related to a recognition platform of the recognizing entity and/or providing the ability for the recognition recipient to interact with the recognizing entity (e.g., account management), certain user interface screens may be accompanied by options to redeem a gift presented as a user interface element (e.g., a box that includes text such as “Thanks for being one of our best employees” and an interactive user interface element (e.g., a button) that includes text such as “Redeem your gift”). A gift may be any item, such as a good, service, gift card, coupon, experience opportunity (e.g., travel, dining, etc.), blockchain based currency or non-fungible token, stock, point reward, etc. Other items may be considered gifts without departing from the scope of embodiments described herein.

In one or more embodiments, prior to such an offer being presented, as part of a UI, to a recognition recipient device 102, a separate portion of the UI may be presented by the recognition system 104, and a recognizing entity may interact with said UI portion in order to interact with a gifting service system 106. In some aspects, the gifting service can select and communicate a recommendation based on an input from the recognition 104. For example, a recognition system can provide a “fitness product” output, and the gifting service system 106 can return data associated with fitness products. Additionally, in some aspects, a recommendation can be mapped to a set of products or a category. This can allow recognition categories, such as “everyday hero” to be mapped to certain products, while other categories, such as “star player” are mapped to a different set of products. In some aspects, this can include creating conflict associations, where certain products are excluded from association with certain recognition categories. The gifting service system 106 may be one or more computing devices such as the computing device 2102 described herein at least in connection with FIG. 21. As an example, the gifting service system 106 may be one or more server computing devices controlled or otherwise used by a gifting service provider (not shown). In one or more embodiments, the gifting service system 106 is configured to provide gifting services, which may include any number of ways to provide users, consumers, businesses, etc. with the ability to offer gifts in a variety of ways for a variety of purposes.

In one or more embodiments, the gifting service system 106 includes a gift order sub-system 108. The gift order sub-system 108 may be one or more computing devices such as the computing device 2102 described herein at least in connection with FIG. 21, or any portion of such computing devices (e.g., the storage device 2112). In one or more embodiments, the gift order sub-system 108 includes a datastore (not shown) that stores any data received from or otherwise obtained and related to any products (e.g., goods and/or services) that may be offered as gifts to a recognition recipient (e.g., product information 110), and any user information 112 associated with any number of users that may be potential recognition recipients.

In one or more embodiments, the product information 110 may be any information related to any product (e.g., any gift and/or service) that may be offered as a gift to any entity. Product information 110 may be obtained from any source. As an example, product information, organized in any suitable one or more data structures, may include any number of products, each associated with any number of details (e.g., customization options, images, quality levels, etc.). Product information may be obtained from any source. As an example, product information 110 may be obtained from any retailer of products with which the gifting service system 106 has a relationship, and/or a partner of such a retailer.

In one or more embodiments, product information 110, provided to the gifting service system 106, may be any information related to any product that may be offered, via the recognition system 104, as a gift to a recognition recipient for which a determination was made that the recognition recipient qualifies to be provided with an option to redeem a gift (e.g., for being an exemplary employee). The product information 110 may include, for example, names of products, identifiers of products, information about products (e.g., size options, color options, style options, etc.), images of products, etc. As another example, the product information 110 may include categorization information defining what one or more categories of products that a given product is in. As another example the product information may include product pricing information. As another example, the product information 110 may include identification of products that a recognizing entity wants to be offered to a recognition recipient when a determination is made to present the recognition recipient with an option to redeem a gift (e.g., for being selected as a recognition recipient). Product information may be dynamically updated in real time. As an example, a retailer or partner of a retailer may provide updated and/or new product information from time to time, which may be used to dynamically update the product information 110.

In one or more embodiments, user information 112 may be any information associated with any entity that may potentially be a recognition recipient. User information 112 may be obtained from the recognition system 104. For example, a user (i.e., a potential recognition recipient) may have created an account with the recognition system 104, and the recognition system 104 may maintain a user profile associated with the user. All or any portion of the information maintained in such a user profile may be provided to the gifting service system 106 as part of the user information 112. User information 112 may further include any information about users obtained by the gifting service system 106 obtained from any other source for any other purpose. As an example, the gifting service system 106 may have interacted with the user previously (e.g., for redeeming a previous gift, providing gifting services, etc.) and obtained information about the user through the interaction. As another example, user information stored in the user information 112 may include data related to users obtained via various online sources (e.g., cookies, clickstream data, search data, purchase data, user profile data, etc.), data corresponding to content presented on a website or application (e.g., dates, product details, images, videos, other advertisements, comments, news stories and headlines, etc.), data obtained from e-mails or social media posts/comments/profiles, etc. User information may be obtained prior to a recognition initiation request being received by the gifting service system 106 from the recognition system 104. Additionally or alternatively, user information 112 may be obtained and/or updated dynamically in real-time before, during, and/or after a recognition initiation request. User information may include any information about a user such as, for example, demographic information (e.g., name, age, location, etc.), history with the recognizing entity, length of time of the relationship (e.g., employment) between the recognizing entity and the user, a time of year (e.g., a holiday season), one or more date ranges of interactions between the user and the recognition system 104, etc., which may be obtained by the gifting service system 106 from a recognition system 104, and/or sources other than the recognition system 104 (e.g., previous interactions with a user, cookies, browser extensions, social media platforms, etc.). User information 112 related to a particular user and/or to one or more groups of users may be referred to as historical user information. In one or more embodiments, historical user information is dynamically updated in real-time as additional information is obtained related to one or more users. As an example, updates may be added to the historical user information as users interact with the recognition system 104, decide whether or not to redeem gifts, make changes to social media profiles, update recognition account profiles, etc.

In one or more embodiments, the gifting service system 106 includes a machine learning system 114. The machine learning system 114 may be implemented on one or more computing devices of the gifting service system 106, such as the computing device 2102 described herein at least in connection with FIG. 21, or any portion of such computing devices. Additionally or alternatively, the machine learning system 114 may be implemented as an application or other executable process on one or more computing devices of the gifting service system 106.

In one or more embodiments, when a recognizing entity seeks to recognize a recognition recipient (e.g., recognize an employee for performance), the recognizing entity may access a UI of the recognition system 104. The UI may include a portion for interacting with the gifting service system 106. The UI portion corresponding to the gifting service system 106 may be an interactive element that, when selected, leads the recognizing entity to a UI provided by the gifting service system 106. Additionally or alternatively, the UI portion may be embedded into the UI of the recognition system 104 by the gifting service system 106 (e.g., via code inserted into the recognition system UI and invoked when a recognizing entity seeks to provide recognition to a recognition recipient). Such a UI portion may include a series of initial questions for the recognizing entity seeking information about the intended recognition. As an example, the information to be provided by the recognizing entity may include an identification if the intended recognition recipient and a recognition amount. A recognition amount may be any representation of value to be associated with the recognition, which may be referred to as a recognition amount quantity. The information may further include any amount of additional recognition information. Such additional recognition information may include, but is not limited to, a recognition type (e.g., recognition for being a ‘team player’, recognition for achieving above and beyond what was expected or required, recognition for achieving a specific goal, etc.), information about the intended recognition recipient (e.g., name, interests, relationship with recognizing entity, etc.). The UI portion of the recognition system 104 may be implemented as part of the UI and configured to transmit and receive information between the recognition system 104 and the gifting service system 106. Additionally or alternatively, the recognition system may include one or more regions where embodied code provided by the gifting service system 106 is executed to present UI portions via which a recognizing entity may provide information to the gifting service system.

In some aspects, recognition as described above (e.g., recognizing by a recognizing entity) can be performed automatically. Such automatic recognition can be performed using a machine learning system, a set of computer-implemented rules, or other such operations. For example, a manager can receive a push notification with the text “It's Kelly's 5 year anniversary”. The automatic recognition can automatically identify the text as associated with a recognition event, and proceed as described above based on the automatic recognition. Such automatic recognition can be used in various systems for milestones or events such as promotions, anniversaries, moving events from one location to another, etc.

In one or more embodiments, in response to receiving a recognition initiation request, including at least recognition quantity information and any additional recognition information, the gifting service system 106 may optionally invoke a stored value converter 122. The stored value converter 122 may be implemented on one or more computing devices of the gifting service system 106, such as the computing device 2102 described herein at least in connection with FIG. 21, or any portion of such computing devices. Additionally or alternatively, the stored value converter 122 may be implemented as an application or other executable process on one or more computing devices of the gifting service system 106. In one or more embodiments, the stored value converter 122 is configured to convert any type of representation of value provided to recognition recipients by the recognition system 104 to a monetary amount that may be used to determine, at least in part, one or more gift options. As an example, the recognition system 104 may provide recognition awards in the form of starts, points, etc. Thus, in one or more embodiments, a recognition quantity amount received by the gifting service system 106 from the recognition system 104 as part of the recognition quantity information of the recognition initiation request may include the recognition quantity represented as the value representation used by the recognition system 104. In one or more embodiments, in order to determine possible gift options for a recognition recipient, the value representation (e.g., stars, points, etc.) is converted into a monetary amount, so that gift options within the monetary amount may be determined. As an example, if fifty stars are to be awarded to a recognition recipient, the recognition quantity information included in the recognition information request may be fifty stars. In such embodiments, the stored value converter 122 may perform a conversion of the fifty star amount into a corresponding dollar amount. The conversion ratio used by the stored value converter 122 may be any ratio, and may be, for example, provided by the recognition system 104 to the gifting service system 106.

In one or more embodiments, also in response to the recognition initiation request, the gifting service system 106 may invoke a gift options algorithm 116 of the machine learning system 114. In one or more embodiments, various gift option information (e.g., one or more gift options, one or more gift categories, etc.) are determined via a gift options algorithm 116 of the machine learning system 114 of the gifting service system 106. The gift options algorithm 116 may be implemented on one or more computing devices of the gifting service system 106, such as the computing device 2102 described herein at least in connection with FIG. 21, or any portion of such computing devices. Additionally or alternatively, the gift options algorithm 116 may be implemented as an application or other executable process on one or more computing devices of the gifting service system 106. The gift options algorithm 116 may be invoked in response to receipt of a recognition initiation request in order to, at least in part, provide gift options information to a recognizing entity via the recognition system 104. As used herein, a gift may be any item and/or service. Examples include, but are not limited to, a physical item, a gift card, a coupon, a service, etc.

In one or more embodiments, the gift options algorithm 116 analyzes user information from the user information 112 and/or product information from the product information 110 in order to determine which one or more gift options to provide to the recognizing entity. As an example, the recognition quantity information and any additional recognition information provided from the recognition system 104 to the gifting service system 106, along with any other user information 112 and/or product information 110, may be used as input to the gift options algorithm 116 in order to determine gift option information to be provided to the recognition system 104. As another example, the analysis may include determining that the user is interested in a particular brand, which is associated with one or more products that are to be offered as gifts. As another example, the analysis may include determining the date on which the recognizing entity interacted with the recognition system 104, and that one or more gift options are to be offered after interactions within a date range that the interaction date is within. In one or more embodiments, all or any portion of the aforementioned example analyses may be performed by the gift options algorithm 116 in combination to determine what one or more gift options should be presented to the recognizing entity.

In one or more embodiments, the gift options algorithm 116 may be or include a machine learning model that is trained to determine what one or more gifts should be presented to the recognizing entity. As an example, such a machine learning model may use information from product information 110 and/or user information 112 in order to predict what potential gift options are more likely to result in a recognition recipient electing to redeem a gift, thereby allowing the recognition recipient to receive recognition (e.g., for exceptional services rendered during the course of employment). In such a scenario, a recognizing entity may have a goal of improving the level of satisfaction of recognition recipients with recognition provided via the recognition system 104. To that end, the machine learning model may be trained to predict which one or more particular gifts of the currently available gift options, when ultimately presented to a recognition recipient, are more likely to cause the recognition recipient to decide to redeem the gift, thus completing the desired recognition, which may, for example, reinforce the behavior that garnered the recognition.

As an example, the trained gift option machine learning model may be trained to determine that recognition recipients having certain demographic characteristics, living in a certain geographic region, that enjoy particular brand, and that have been associated with the recognizing entity for more than a certain length of time are more likely to select to redeem the gift when a certain type of gift option is presented to the recognition recipient. The machine learning model may be dynamically updated via continuous training over time to improve its predictive accuracy by adding product information 110 and/or user information 112, the gift options presented in the offer or other offers for similar recognition recipients, the results of whether the offer resulted in the redeeming of a gift, the acceptance of the gift by the recognition recipient, and whether the recognition recipient redeeming the gift exhibited desired behavior after the redemption, to the training data set for the machine learning model, thereby allowing the machine learning model to better predict gift options that are more likely to result in the redeeming of a gift.

Other machine learning techniques may be used as part of the gift options algorithm 116 without departing from the scope of embodiments described herein. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the product information and/or user information associated with or existing at the time of a given user interaction with the recognition system 104 had characteristics similar to other users and/or gifts for which an offer to redeem a gift was made and resulted in the outcome(s) desired by the provider.

In one or more embodiments, after execution of the gift options algorithm 116, results related thereto may be provided from the gifting service system 106 to the recognition system 104. Such results may be included in gift option information. In one or more embodiments, gift option information includes, but is not limited to, one or more possible gift options, one or more categories of gift options, and/or any other information relating to the possible gifts (e.g., a converted monetary amount calculated by the stored value converter 122 that the gift options fall within). The gift option information, in whole or in part, may be presented to a recognizing entity via the UI of the recognition system 104. The gift option information may, as an example, be presented as one or more UI interactive elements that allow the recognizing entity to make selections related thereto. As an example, based on the information included in the recognition initiation request, the gift options algorithm 116 may generate any number of possible gift options within the recognition quantity amount of the recognition quantity information, and the recognizing entity may be presented with UI elements that allow the recognizing entity to select one or more of the gift options. As another example, based on the information included in the recognition initiation request, the gift options algorithm 116 may generate any number of possible gift option categories that include gifts within the recognition quantity amount of the recognition quantity information, and the recognizing entity may be presented with UI elements that allow the recognizing entity to select one or more of the gift categories, from which gift options will be generated for presentation to a recognition recipient via the recognition recipient device 102.

In one or more embodiments, in response to the gift option information received from the gifting service system 106, a recognizing entity may make one or more selections, which may be transmitted from the recognition system 104 to the gifting service system 106 as gift selection information. As an example, one or more gift options, or one or more gift option categories, may be selected by the recognizing entity via the UI interactive elements presented within the UI of the recognition system 104, and the selections may be transmitted to the gifting service system 106.

In one or more embodiments, although not shown in FIG. 1, the machine learning system 114 shown in FIG. 1 may also include a recognition recipient selection algorithm. In one or more embodiments, in addition to or as an alternative to a recognizing entity selecting a recognition recipient, and causing the transmission of a recognition initiation request from the recognition system 104 to the gifting service system 106, the recognition system 104 may provide information to the gifting service system 106 to allow the gifting service system 106 to determine, at least in part, when a recognition recipient should be recognized via receiving a recognition award redeemable for gift options. As an example, the recognition system 104 may provide the gifting service system 106 with any number of rules, parameters, etc. that may be included in a recognition recipient algorithm to be evaluated. Such evaluation of potential recognition recipients may be performed on an on-going basis and/or in response to a request received from the recognition system 104. In one or more embodiments, the recognition recipient algorithm may be implemented as a machine learning model. Such a machine learning model may be trained to determine that providing recognition to a potential recognition recipient is likely to achieve one or more goals of the recognizing entity. For example, user information may be assessed by the machine learning model to determine that a certain potential recognition recipient employee having certain characteristics (e.g., time at employer, salary, demographics, etc.) is more likely to be satisfied with their employment and remain with the employer if a recognition award is provided, and recommend to the recognizing entity associated with the recognition system 104 to provide a recognition award to the employee. In one or more embodiments, such a recommendation may result in the recognizing entity beginning a recognition initiation request, as described above.

In one or more embodiments, in response to the gift selection information, the gifting service system 106 may again invoke the gift options algorithm 116. In one or more embodiments, the gift selection information may be added to the inputs for the gift options algorithm 116 to further generate gift options to be presented to a recognition recipient via the recognition recipient device 102.

In one or more embodiments, the gift options generated by the gift options algorithm 116 using the gift selection information from the recognition system 104, the user information 112, the product information 110, etc. may be provided to the recognition system 104 from the gifting service system 106. In one or more embodiments, the gift options are intended to be presented to a recognition recipient via a recognition recipient device 102. As an example, the gift options may be stored by the recognition system 104 until the next time the intended recognition recipient accesses the recognition system 104 via the recognition recipient device 102.

In one or more embodiments, once the intended recognition recipient accesses the recognition system 104 (e.g., using the recognition recipient device 102), the recognition system 104 presents the gift options provided by the gifting service system 106 to the recognition recipient. As an example, when the recognition recipient accesses the recognition system 104, the recognition recipient may be presented with a series of one or more screens of a UI that inform the recognition recipient that the recognition recipient has received a recognition award, the amount of the award (e.g., using the alternate value representation used by the recognition system), information explaining the reasons for the granting of the award, etc. The recognition recipient may also be presented with the gift options. In one or more embodiments, the gift options include the one or more gift options selected by the recognizing entity, one or more gift options from within the one or more categories selected by the recognizing entity, etc. The gift options presented to the recognition recipient may also include one or more alternate gift options curated for the recognition recipient (e.g., based on user information 112 and/or product information 110) that the recognition recipient may select instead of the one or more gift options selected by the recognizing entity, as well as one or more alternate redemption options (e.g., donate the recognition quantity, regift one or more of the gift options, add the recognition quantity to as a stored value quantity to a value store amount maintained by the recognition system 104 for the recognition recipient, etc.).

In one or more embodiments, to provide the gift options, the gifting service system 106 may direct the recognition recipient (e.g., via an embedded UI interactive element within the UI of the recognition system 104) to a user interface (i.e., a webpage, mobile application screen, etc.) generated by the gifting service system 106. The user interface may include a presentation of the one or more gift options, such as an image, name, description, etc. of the various gift options. If there is more than one option of what gift may be received, the user interface may include a presentation of the various options via images, names, and/or descriptions of the gifts and a request to select from among the options (e.g., “What gift would you like to receive?”).

The gift options may include any other information without departing from the scope of embodiments described herein. As an example, the gift options may include an image of virtual gift wrapping, and an interactive element that, when selected by the user, reveals (e.g., “unwraps”) the gift. The interactive element may include a signal indicating to the user to select the interactive element to begin the gift redemption process (e.g., “SEE YOUR GIFT”) As another example, the gift options may include explanatory information that provides the user with various details related to the receipt of the gift (e.g., “You have received a gift from [the recognizing entity]. To redeem your gift, select the button above, and provide your address to have your gift shipped to you”). As another example, the gift options may include information that provides the user with other details about the gift redemption process (e.g., that the recipient will have the option to exchange the gift for another gift, that the recipient will have the option to select certain customization options related to the gift, that the user may have one or more alternate redemption options, etc.).

In one or more embodiments, the one or more gift options presented to the recognition recipient may depend on when the recognition recipient access the recognition system 104 (i.e., the timing of the selection to select a gift). For example, in some aspects, the recipient has selected a similar product from previous recognition rewards, and the system may implement operations to prevent duplication of a previous experience (e.g., presentation of a same or similar set of items). In such a scenario, the recognition recipient may not immediately access the recognition system 104 to see the intended recognition award, or may not immediately select to redeem the gift. Thus, the one or more gift options that would be presented to the recognition recipient may have changed since the time that the gift options were generated. For example, some or all of the gift options that would have been presented if the recognition recipient had elected to redeem a gift near the time that the gift options were generated may no longer be available (e.g., there were 1000 of a certain gift, but all have already been redeemed). Therefore, the gift options algorithm 116 may be invoked (possibly again) at the time the recognition recipient selects to redeem the gift in order to determine gift options that are available at the time of the redemption selection to be presented to the recognition recipient.

The gift options user interface to which the recognition recipient is directed may also provide various options to the recognition recipient. Such options may include, but are not limited to, the option to accept the gift offered, to exchange the gift for another gift, to donate the value of the gift (e.g., to a charity), to regift one of the gift options to a regift recipient, etc. The user interface may include one or more alternate gifts that the recognition recipient may choose to exchange for the one or more gifts selected by the gift options algorithm 116. The alternate gifts may be presented using an image, a name, and/or details of the one or more alternate gifts.

In one or more embodiments, the user interface presenting the one or more gift options to the recognition recipient includes an interactive element (e.g., a button, link, etc.) that, when selected (after selecting a gift if more than one is offered), navigates the user to another user interface where additional information is requested from the recognition recipient. The user interface may include any number of different requests for information from the recognition recipient. As an example, the page may request that the recognition recipient select a communication channel (e.g., email, text, messenger service, printed mail delivery, etc.) through which the recognition recipient wants to receive information related to the gift. As another example, the UI may include a request for a user identifier. The user identifier may include a preferred name of the recognition recipient, as well as information that facilitates the gifting service system 106 to interact with the recognition recipient via the recognition recipient's selected communication channel (e.g., an email address, a phone number, etc.).

The user interface may also include an interactive element that, when selected, allows the recognition recipient to continue the gift redemption process. The interactive element may change, depending on other selections made by the recognition recipient. For example, the interactive element may be a button that, when selected by the recognition recipient, navigates the recognition recipient to another portion of the user interface to continue the gift redemption process. The interactive element may include a signal indicating to the recognition recipient to select the interactive element to continue the process. The signal may, for example, be text, which may change based on other selections of the recognition recipient. As an example, the text may state “Continue” if the recognition recipient checks a check element on the page indicating that they would prefer to continue with the one of the gifts presented in the gift options, but change to “Exchange this gift” if the recognition recipient checks a check element indicating that they would prefer to exchange the gift for an alternate gift. In one or more embodiments, if the recognition recipient makes a selection indicating that the recognition recipient wants to exchange the gift, then the elements on the user interface presenting the one or more alternate gift options may be selectable to allow the recognition recipient to indicate which alternate gift the recognition recipient prefers. In such a scenario, the page may also include an indication to the recognition recipient that the recognition recipient should select from among the alternate gift options. In one or more embodiments, the alternate gift options presented to the recognition recipient, as discussed above, are determined by the gift options algorithm 116.

In one or more embodiments, once the recognition recipient has selected a gift, the recognition recipient may be presented with various customization options (e.g., size, color, etc.) and requests for information (e.g., address to send the gift to, preferred delivery options, etc.). The collective information that includes selected gift, gift customization selections, address, preferred delivery options, preferred communication channel, user identifier, etc. may be referred to as redemption information. The redemption information may be transmitted from the recognition recipient device 102 to the gifting service system 106. Additionally or alternatively, the redemption information may be provided from the recognition recipient device 102 to the recognition system 104, and, in turn, provided from the recognition system 104 to the gifting service system 106.

Although the above description contemplates various presentations and user interface portions provided to the recognition recipient to complete the gift redemption process, all or any portion of the presentations may be combined into a single user interface portion, or divided differently into separate user interface portions, without departing from the scope of embodiments described herein. As such, in one or more embodiments, the redemption information may be transmitted to the gifting service system 106 as a single transmission, or as a series of transmissions.

In one or more embodiments, once the recognition recipient has made all necessary selections and provided the requested information (which may be referred to collectively as redemption information), the redemption information is transmitted from the recognition recipient device 102 to the gifting service system 106 (e.g., either directly or via the recognition system 104). In one or more embodiments, based at least in part on the redemption information, the gifting service system 106 initiates delivery of the selected gift to the recognition recipient. The method of delivery may be based on one or more selections made by the recognition recipient during the gift redemption process by which the user indicated a preferred method of delivery. As an example, the gift may be a gift card, and the recognition recipient may have selected to receive the gift card as a virtual gift card delivered via email. Similarly, for a gift of stock, the gift can be “delivered” to a brokerage account associated with the recognition recipient. In some aspects, a recognition recipient can provide such information as part of a user preference setting within a system. As another example, the gift may be a physical object, and the recognition recipient may have provided a physical address to which the gift is shipped. The gifting service system 106 may perform the delivery of the gift. Additionally or alternatively, the gifting service system 106 may provide information related to the planned delivery to the recognition system 104, and the recognition system 104 may perform the delivery of the gift to the recognition recipient (e.g., deliver the gift to the office of the recognition recipient on the campus of the employer providing the recognition).

In one or more embodiments, regardless of which entity performs the delivery of the gift, information related to the recognition recipient may be provided to the recognition system 104, thereby providing the recognizing entity with information including that a gift was redeemed by the recognition recipient, what the gift was, and/or any other information obtained during the gift redemption process. In one or more embodiments, all or any portion of any information obtained related to the recognition recipient during the gift redemption process is used by the gifting service system 106 to dynamically update historical data maintained by the gifting service system 106, which may be used to dynamically update the machine learning models of the gift options algorithm 116 by adding the obtained information in real-time to the training data sets for the machine learning models.

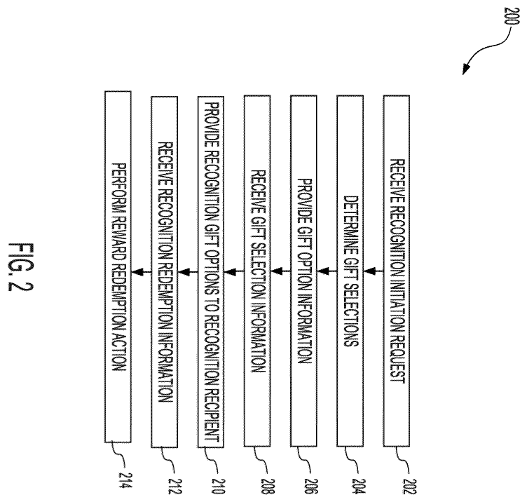

FIG. 2 shows an illustrative example of a process 200 for providing recognition awards to recognition recipients in accordance with one or more embodiments described herein. The process 200 may be performed, for example, by a gifting service system, such as the gifting service system 106 shown in FIG. 1 and described above.

At step 202, a recognition initiation request is received. In one or more embodiments, the recognition initiation request is received by a gifting service system (e.g., the gifting service system 106 of FIG. 1) from a recognition system (e.g., the recognition system 104 of FIG. 1). As an example a recognizing entity (e.g., an employee manager at an employer) may access a UI of the recognition system. The UI may include a UI portion provided by and/or embedded by the gifting service system for providing gift options as recognition awards. In one or more embodiments, the recognition initiation request includes a request to provide one or more gift options as a recognition award to a recognition recipient (e.g., an employee). In one or more embodiments, via the UI portion of the recognition system associated with the gifting service system, the recognizing entity may provide any amount of information to the gifting service system as part of the recognition initiation request. Such information includes, but is not limited to, a quantity (e.g., represented by a recognition quantity amount) of the recognition, an identification of the intended recognition recipient and additional recognition information. In one or more embodiments, the identification of the intended recognition recipient may include any suitable form of identifying the intended recognition recipient (e.g., name, email address, employee number, etc.). In one or more embodiments, the additional recognition information may include, but is not limited to, information about the intended recognition recipient (e.g., demographic information, likes, dislikes, information related to history with the recognizing entity, etc.), a recognition type (e.g., recognition is for being a team player, for years of service, for performing a specific task above expectations, etc.) etc. In one or more embodiments, in addition to the information provided as part of the recognition initiation request, the gifting service system may obtain any amount of other information from any source. As an example, the gifting service system may obtain any other information associated with the intended recognition recipient from a user information data store of the gifting service system (e.g., from historical user data). As another example, the gifting service system 106 may dynamically, in real-time, obtain other information about the intended recognition recipient from other sources (e.g., social media, cookies, clickstream data, search data, user profile data, etc.). The gifting service system may obtain any other information in response to the recognition initiation request without departing from the scope of embodiments described herein (e.g., updated information related to the recognizing entity, the entity associated with the recognition system, the geographic location of the recognizing entity and/or intended recognition recipient, the time of year (e.g., a certain holiday is approaching), current events, etc.).

At step 204, the information obtained in step 202 as part of the recognition initiation request, and/or from any other sources, is provided to a gift options algorithm of the gifting service system to determine one or more gift selections. The gift selections may be an output of a gift options algorithm (e.g., the gift options algorithm 116 of FIG. 1). The gift selections may be any one or more specific gifts, any one or more categories of gifts, etc. In one or more embodiments, prior to determining the gift selections, the gifting service system may convert the recognition award amount (i.e., the recognition quantity information) from a stored value quantity (e.g., the number of stars, points, etc. being awarded) to a monetary amount (e.g., using the stored value converter 122 of FIG. 1). The monetary amount of the recognition may determine, for example, a cap on, or range of value, that the various gift selections should be within. In one or more embodiments, within the monetary value converted from the recognition quantity amount received in the recognition initiation request as part of the recognition quantity information, the gift selections (e.g., one or more gift options, gift categories, etc.) may be determined based on other information (e.g., user information associated with the intended recognition recipient, product information, etc.)

At step 206, the gift selections determined in step 204 are provided from the gifting service system to the recognition system as part of gift option information. Gift option information may include any number of gift options, gift categories, etc., as determined by the gift options algorithm of the gifting service system. Gift option information can, for example, include a plurality of gift choices including specific gift choices having a specific universal product code or general gift choices having a merchant category code. For selections of specific or general gift choices, the gift choices can be generated manually by a gifter selecting the specific product options (e.g., a specific clothing design and color of a specific brand) or a genera category (e.g., toy cars, board games, pants, shirts, etc.) The gift option information may include any amount of additional information without departing from the scope of embodiments described herein. As an example, the gift options information may include information allowing the gift options from which the recognizing entity will select to be presented to the recognizing entity as part of the UI provided by the recognition system. In such an example, the gift selection options may be presented in the UI as one or more UI interactive elements, which the recognizing entity may choose in order to select the one or more gift options in order to continue the recognition process.

At step 208, gift selection information is received at the gifting service system from the recognition system. In one or more embodiments, the gift selection information includes the one or more gifts and/or gift categories selected by the recognizing entity (e.g., using the UI of the recognition system).

At step 210, in response to receiving the gift selection information, the gifting service system may again invoke the gift options algorithm to determine gift options to provide to the intended recognition recipient. In one or more embodiments, the gift options will include one or more gifts selected by the recognizing entity, one or more gifts from one or more categories selected by the recognizing entity, and/or any other gift options and/or redemption options. As an example, in addition to any gift options selected by the recognizing entity, the gift options algorithm may determine one or more alternate gift options for the intended recognition recipient, based at least in part on user information associated with the intended recognition recipient. Such alternate gift options may, for example, be determined by a machine learning model implementing the gift options algorithm that is trained to predict gift options that increase the likelihood that the intended recognition recipient will choose to redeem a gift option, and thus receive the intended recognition. As another example, the gift options algorithm may determine that the intended recognition recipient should be offered one or more alternate redemption options, such as the opportunity to donate the value of the recognition award, the opportunity to select a gift option and regift the gift option to a separate regift recipient, the option to add the value of the recognition award to a value store amount representing an aggregate amount of recognition awards received by the intended recognition recipient, etc. In one or more embodiments, providing recognition gift options to an intended recognition recipient includes transmitting the recognition gift options from the gifting service system to a recognition recipient device. In one or more embodiments, providing recognition gift options to an intended recognition recipient includes providing the recognition gift options to the recognition system, which may, for example, store the recognition gift options to be presented to the intended recognition recipient the next time the intended recognition recipient accesses the recognition system (e.g., to redeem the recognition award).

In one or more embodiments, providing recognition gift options to an intended recognition recipient, whether directly from the gifting service system or via the recognition system, includes including additional information. Such additional information may include, as an example, a series of information requests, which may differ based on the interaction of the intended recognition recipient with the recognition gift options. As an example, if the intended recognition recipient selects to redeem a particular gift (e.g., one of the gifts selected by the recognizing entity), the gift options may further include a request that the recognition recipient provide customization options (e.g., size, color, etc.) for the selected gift, shipping information, etc. As another example, if the recognition recipient selects an alternate gift option (e.g., a gift other than one selected by the recognizing entity), the gift options may further include a request for the recognition recipient to select from among the alternate gift options, customization information for the gift selected, shipping information, etc. As another example, if the recognition recipient is presented with an option to donate the value of the recognition award, the gift options may include a request for the recognition recipient to select, specify, etc. an intended donation recipient (e.g., one or more charities). As another example, if the recognition recipient is presented with an option to regift the recognition gift to a regift recipient, the gift options may include a request for the recognition recipient to provide information related to the intended regift recipient (e.g., name, preferred communication channel, etc.).

At step 212, recognition redemption information is received by the gifting service system. In one or more embodiments, recognition redemption information is received at the gifting service system from the recognition recipient device, either directly or via the recognition system. Redemption information may include any information relating to how a recognition recipient prefers to redeem a gift. If the user elects to receive a gift, redemption information may include, but is not limited to, a selection of a particular gift, customization options for the selected gift, a user identifier, a communication channel to receive information about the gift, preferred delivery options, delivery address, etc. Redemption information may include a selection of an alternate redemption option. In one or more embodiments, when the alternate redemption option is to regift a gift, the redemption information may include information relating to the intended regift recipient (as discussed above). In one or more embodiments, when the alternate redemption option is to donate the gift, the redemption information may include information related to the intended donation recipient (as discussed above).

At step 214. A reward redemption action is performed. Examples of a reward redemption action may include, but are not limited to, delivering a gift to the user, delivering the gift to a regift recipient, donating the value of the gift to a donation recipient, providing information related to the gift redemption process to a provider, and/or updating various machine learning models in real time with information obtained during the gift redemption process.

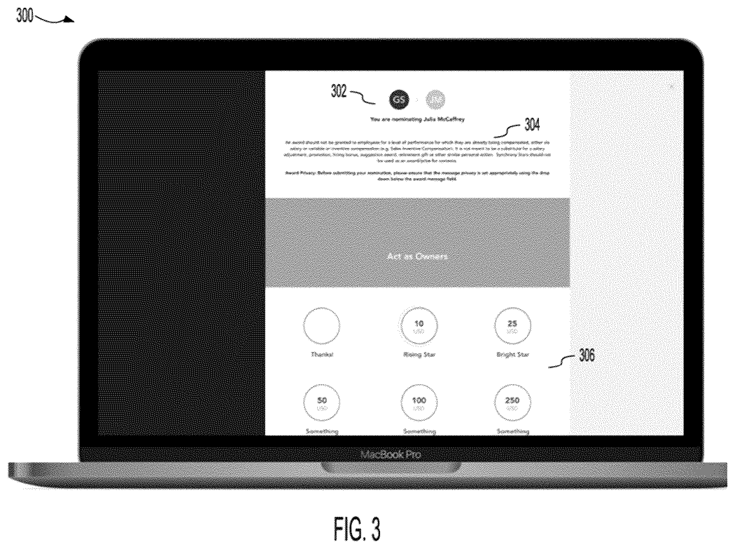

FIGS. 3-18 show illustrative examples of a recognizing entity accessing a UI of a recognition system to provide a recognition award to a recognition recipient in accordance with one or more embodiments described herein. The following examples are for explanatory purposes only and not intended to limit the scope of embodiments described herein. Additionally, while the examples show certain aspects of embodiments described herein, all possible aspects of such embodiments may not be illustrated in these particular examples. These examples are intended to be simple examples to illustrate, at least in part, concepts described herein.

Referring to FIG. 3, FIG. 3 illustrates an example of a user interface 300. The user interface element 300 may be presented as part of a user interface of a recognition system. The user interface 300 may be presented after a recognizing entity has chosen to initiate a recognition process. In this example scenario, the recognizing entity may have accessed a UI of a recognition system seeking to provide a recognition award. To that end, the recognizing entity may have selected to recognize an employee names ‘Julia McCaffrey’. Such a selection may have led the recognizing entity to the UI 300. The UI 300 may include a UI portion 302 that indicates that the recognizing entity (e.g., identified as ‘GS’) has selected to recognize a recognition recipient ‘Julia McCaffrey’ (e.g., ‘JM’). The UI 300 may also include additional information 304 related to various parameters and reasons why a recognition recipient should be selected for recognition.

The UI 300 may also include a portion 306 allowing the recognizing entity to select a recognition quantity amount, which may be associated with a particular description associated with the amount. As an example, the recognizing entity may select to merely thank the recognition recipient. As another example, the recognizing entity may select to identify the recognition recipient (i.e., Julia McCaffrey) as a ‘Bright Star’ that is to receive a recognition award of 25 dollars.

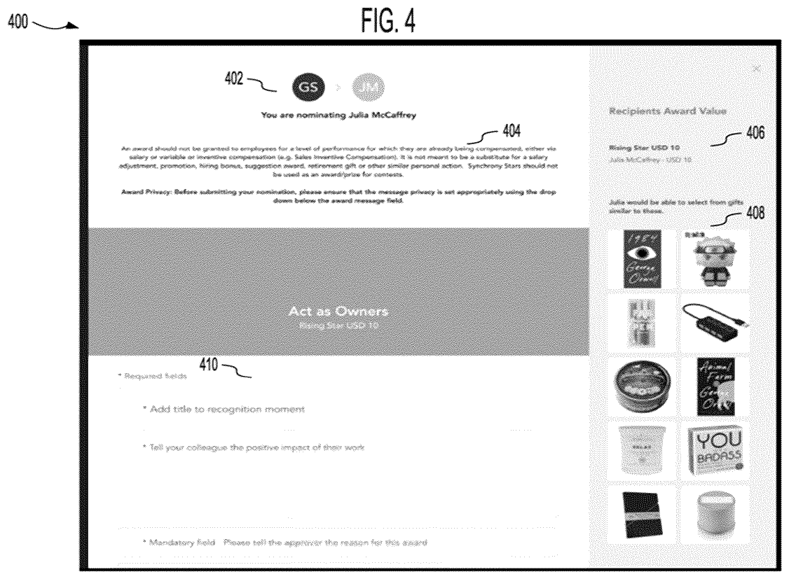

Referring to FIG. 4, FIG. 4 illustrates an example of a UI portion 400 of a recognition system that may be presented to a recognizing entity after the recognizing entity completes the UI portion 300 shown in FIG. 3. As shown in FIG. 4, the UI portion 400 includes an indication 402 of the intended recognition recipient (e.g., Julia McCaffrey) and additional information 404 related to various parameters and reasons why the recognition recipient should be selected for recognition.

The UI portion 400 also includes a recognition quantity amount 406. The recognition quantity amount may have been directly specified by the recognizing entity, or may have been converted from a stored value quantity to a dollar amount. The UI portion 400 may also include a gift options portion 408 that includes gift selection information related to the types of gifts that may be similar to the types of gifts that the intended recognition recipient may be presented that are selected by a gift options algorithm of a gifting service system and that are within the recognition quantity amount. Such gift options may be based on the recognition quantity amount specified by the recognizing entity as part of the recognition quantity information, as well as any other user information and/or product information obtained by and/or otherwise available to the gifting service system. In some aspects, the recognition quantity amount can be associated with a recognition recipient classification, such as a “rising star” classification, a “first time recipient” classification, or other such classifications that can be used based on the recognition quantity amount. The UI portion 400 also includes an additional information section 410 that allows the recognizing entity to enter any additional information about the recognition and/or the recognition recipient, such as a title related to the recognition, a message for the intended recognition recipient, a reason for the recognition award, etc.

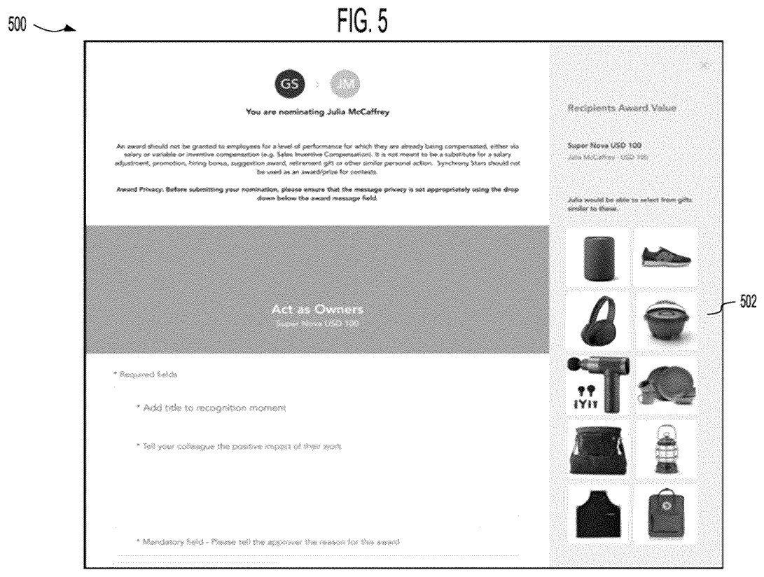

Referring to FIG. 5, FIG. 5 illustrates an example of a UI portion 500 of a recognition system that may be presented to a recognizing entity after the recognizing entity completes the UI portion 300 shown in FIG. 3. FIG. 5 shows UI portion 500 as a different UI portion than the UI portion 400 shown in FIG. 4, with the difference relating to the gift options 502 shown in FIG. 5. The gift options 502 shown in FIG. 5 represent a different selection of gifts than the gift options 408 shown in FIG. 4, which is based on the recognizing entity having selected a greater recognition quantity amount (e.g., 100 vs 10) selected by the recognizing entity.

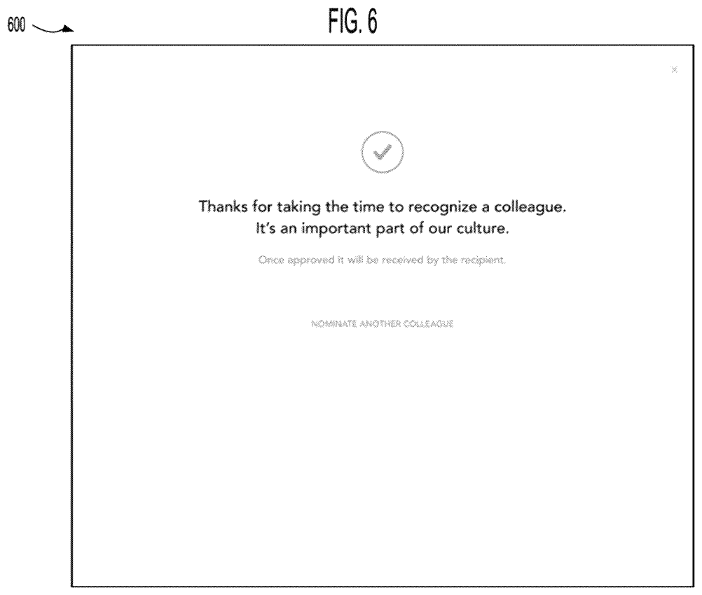

Referring to FIG. 6, FIG. 6 shows a UI portion 600 of a recognition system that may be presented to a recognizing entity after the recognizing entity has selected an intended recognition recipient, provided a recognition quantity amount as recognition quantity information, and any additional recognition information related to the intended recognition of the recognition recipient. The UI portion 600 includes an indication of thanks to the recognizing entity for taking the time to recognize the intended recognition recipient, an indication that the recognition recipient may receive notice of the recognition award once approved, and an option to begin a recognition process for another intended recognition recipient.

In one or more embodiments, once the recognizing entity has selected a gift option from the various options presented based on the recognition quantity amount (e.g., the gift options 408 or the gift options 502), the intended recognition recipient may be alerted that a recognition award has been given to the intended recognition recipient. The intended recognition recipient may, in response to the alert, access the UI of the recognition system and be presented with the gift option selected by the recognizing entity, as well as any alternate gift options and/or alternate redemption options (e.g., donation, regift, bank recognition quantity amount for future use, etc.). The recognition recipient may then begin the gift redemption process to interact with the gifting service system and initiate a recognition redemption action set to be performed by the gifting service system.

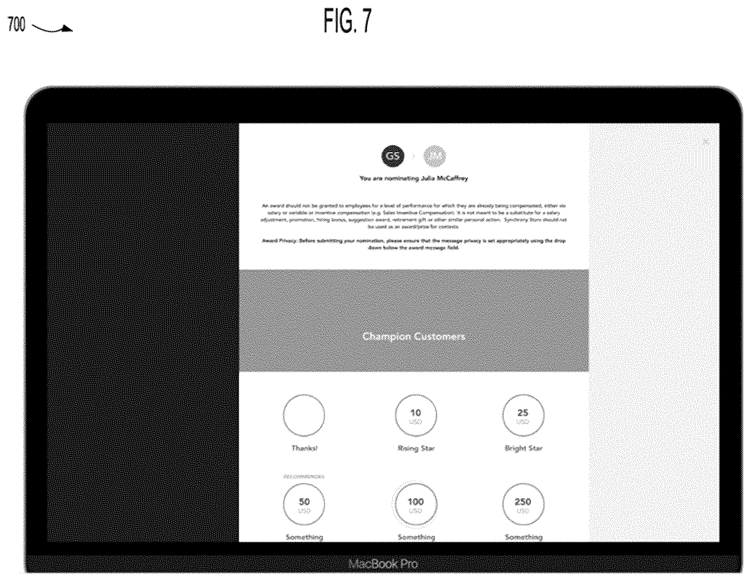

Referring to FIG. 7, FIG. 7 shows a UI portion 700 that is similar to the UI portion 300 shown in FIG. 3, in which a recognizing entity has selected to provide a recognition recipient (i.e., Julia McCaffrey) with a recognition award, and provides the recognizing entity the option to select the recognition quantity amount to be included as recognition quantity information.

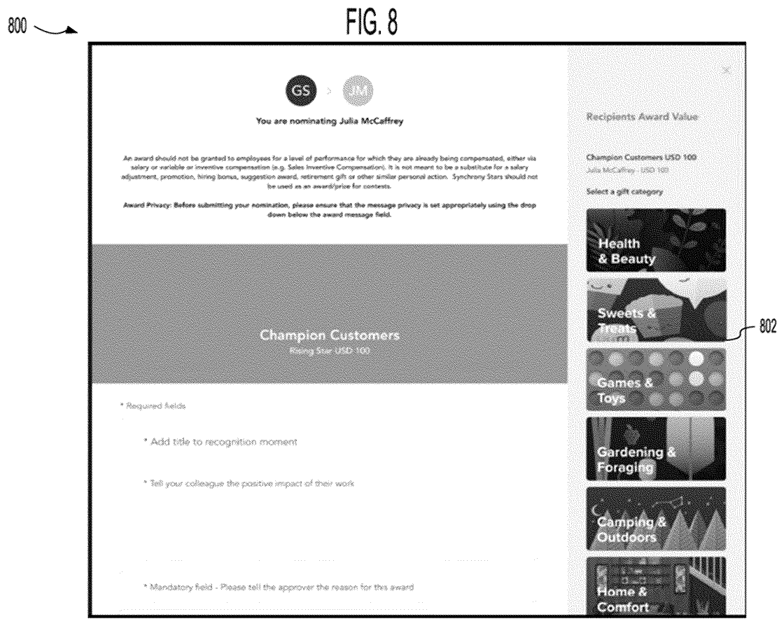

Referring to FIG. 8, FIG. 8 shows a UI portion 800 that is similar to the UI portion 400 shown in FIG. 4. The UI portion of FIG. 8 differs from the UI portion 400 of FIG. 4 in that, instead of certain gift options being presented to the recognizing entity based on the recognition quantity information, gift option categories 802 are presented. The gift option categories 802 may be generated by the gift options algorithm of a gifting service system based on any user information, product information, any information related to the recognizing entity, the recognition system, etc. The gift option categories 802 may be filtered to include only categories that include gift options that are within the recognition quantity information specified by the recognizing entity in response to the UI portion 700 shown in FIG. 7. In some aspects, such filtering can be performed by category maps that include matches. In other aspects, such matches can be part of a more complex product suggestion mapping, including product suggestions based on category matching, category mismatches (e.g., products not preferred for a certain recognition category), prior gift history for a recipient, etc.

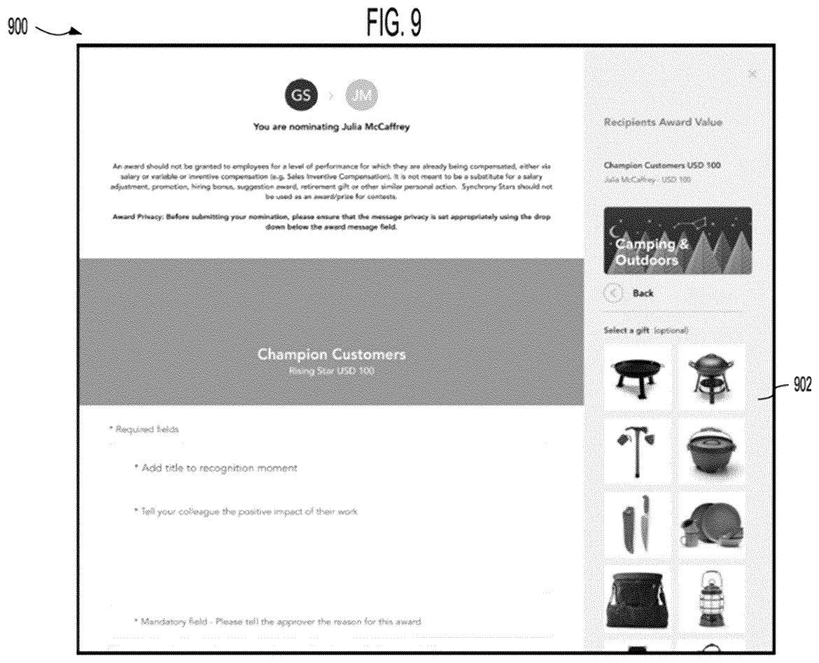

Referring to FIG. 9, FIG. 9 shows a UI portion 900 that may be presented to a recognizing entity after the recognizing entity selects a gift options category from among the gift options categories 802 shown in FIG. 8. The gift options 902 presented to the recognizing entity may be based, at least in part, on a combination of the gift category selected and the recognition quantity information specified by the recognizing entity (e.g., in response to the UI portion 700 shown in FIG. 7). As such, the gift options 902 may include any number of gift options that are within the selected gift options category (e.g., ‘Camping and Outdoors’) and within the recognition quantity amount.

In one or more embodiments, once the recognizing entity has selected a gift option from the various options presented based on the recognition quantity amount (e.g., the gift options 902), the intended recognition recipient may be alerted that a recognition award has been given to the intended recognition recipient. The intended recognition recipient may, in response to the alert, access the UI of the recognition system and be presented with the gift option selected by the recognizing entity, as well as any alternate gift options and/or alternate redemption options (e.g., donation, regift, bank recognition quantity amount for future use, etc.). The recognition recipient may then begin the gift redemption process to interact with the gifting service system and initiate a recognition redemption action set to be performed by the gifting service system.

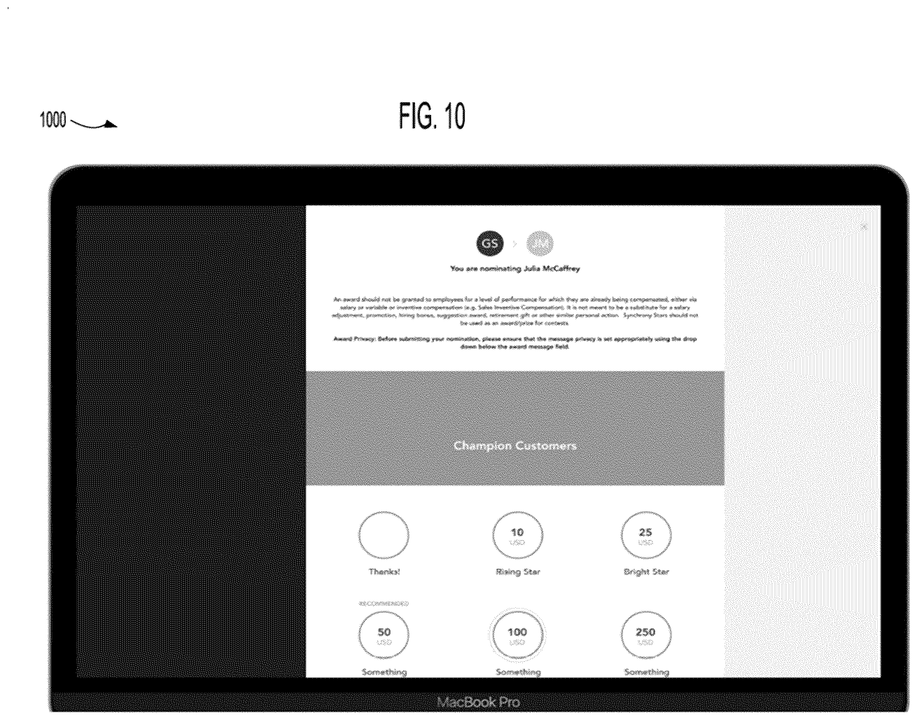

Referring to FIG. 10, FIG. 10 shows a UI portion 1000 that is similar to the UI portion 300 shown in FIG. 3 and the UI portion 700 shown in FIG. 7, in which a recognizing entity has selected to provide a recognition recipient (i.e., Julia McCaffrey) with a recognition award, and provides the recognizing entity the option to select the recognition quantity amount to be include in recognition quantity information.

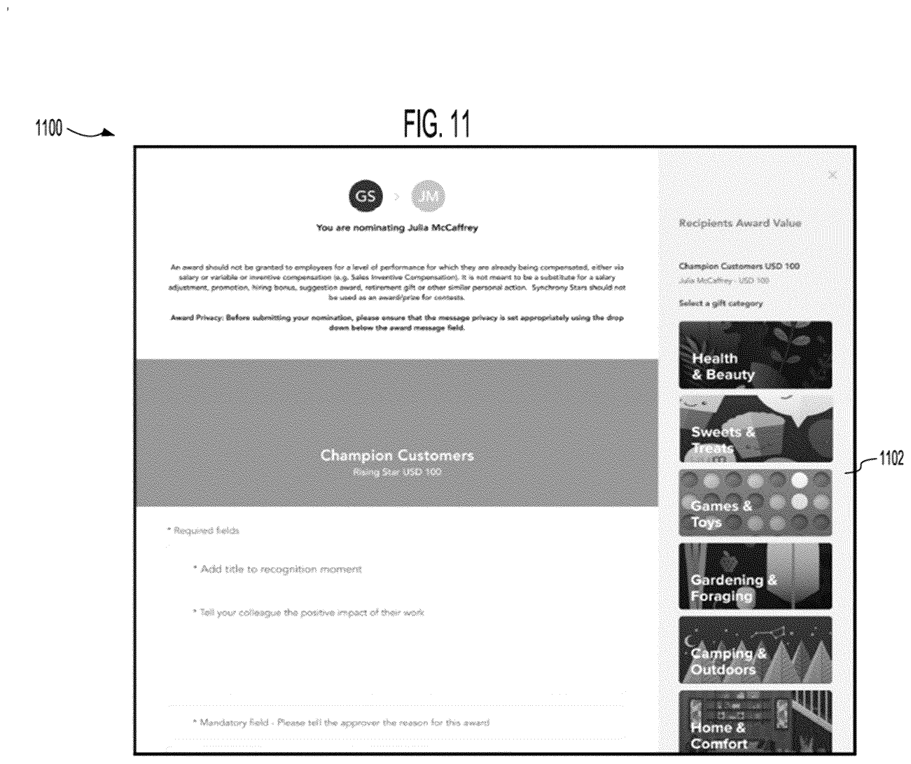

Referring to FIG. 11, FIG. 11 shows a UI portion 1100 that is similar to the UI portion 800 shown in FIG. 8, and includes a presentation of various gift option categories 1102. The gift option categories 1102 may be generated by the gift options algorithm of a gifting service system based on any user information, product information, any information related to the recognizing entity, the recognition system, etc. The gift option categories 1102 may be filtered to include only categories that include gift options that are within the recognition quantity information specified by the recognizing entity in response to the UI portion 1000 shown in FIG. 10.

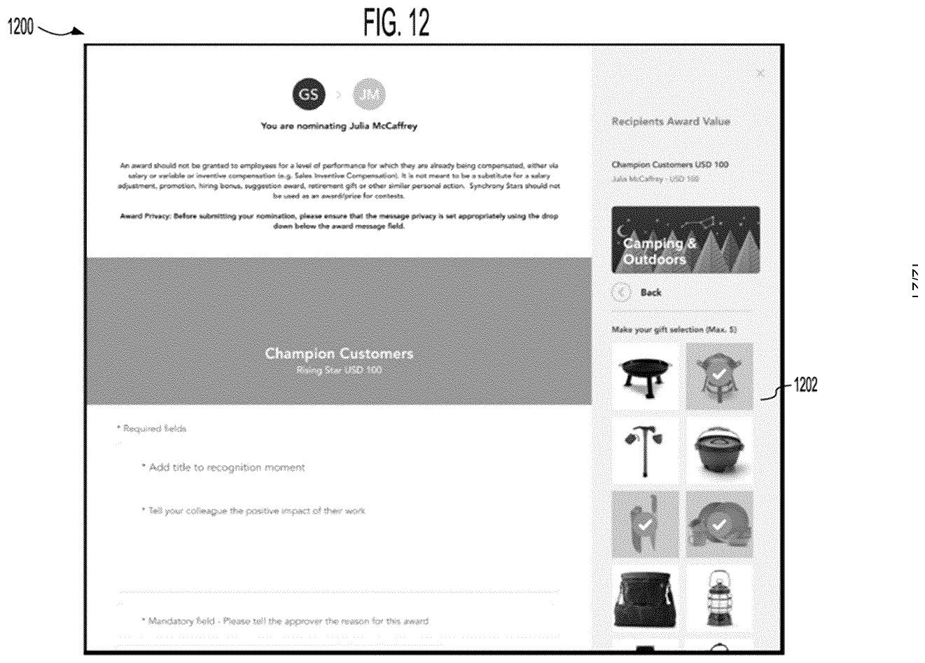

Referring to FIG. 12. FIG. 12 shows a UI portion 1200 that may be presented to a recognizing entity after the recognizing entity selects a gift options category from among the gift options categories 1102 shown in FIG. 11. The gift options 1202 presented to the recognizing entity may be based, at least in part, on a combination of the gift category selected and the recognition quantity information specified by the recognizing entity (e.g., in response to the UI portion 1000 shown in FIG. 10). As such, the gift options 1202 may include any number of gift options that are within the selected gift options category (e.g., ‘Camping and Outdoors’) and within the recognition quantity amount. The UI portion 1200 of FIG. 12 differs from the UI portion 900 of FIG. 9 in that, as shown via check marks in FIG. 12, the recognizing entity may select multiple gift options (e.g., the three selections shown in FIG. 12). The multiple selections shown in FIG. 12 may each be presented as gift options to the intended recognition recipient once the intended recognition recipient begins the recognition redemption process.

In one or more embodiments, once the recognizing entity has selected the multiple gift options from the various options presented based on the recognition quantity amount (e.g., the gift options 902) and within the gift category selected from among the gift option categories 1102, the intended recognition recipient may be alerted that a recognition award has been given to the intended recognition recipient. The intended recognition recipient may, in response to the alert, access the UI of the recognition system and be presented with the gift option selected by the recognizing entity, as well as any alternate gift options and/or alternate redemption options (e.g., donation, regift, bank recognition quantity amount for future use, etc.). The recognition recipient may then begin the gift redemption process to interact with the gifting service system and initiate a recognition redemption action set to be performed by the gifting service system.

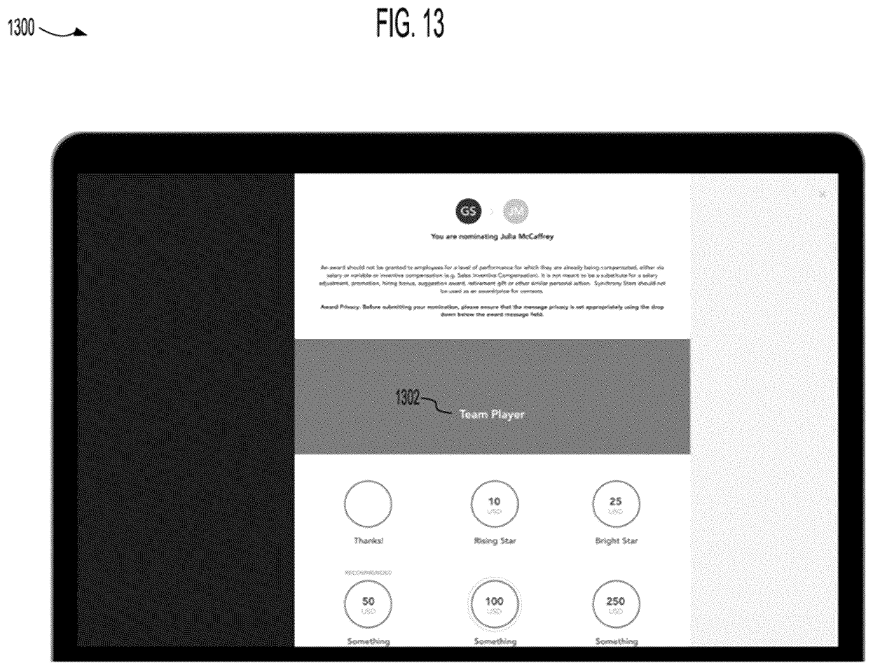

Referring to FIG. 13, FIG. 13 shows a UI portion 1300 that is similar to the UI portion 300 shown in FIG. 3, the UI portion 700 shown in FIG. 7, and the UI portion 1000 shown in FIG. 10, in which a recognizing entity has selected to provide a recognition recipient (i.e., Julia McCaffrey) with a recognition award, and provides the recognizing entity the option to select the recognition quantity amount. The UI portion 1300 differs from the aforementioned UI portions (e.g., 300, 700, 1000) in that the recognizing entity, on a prior UI portion, has selected a recognition type 1302 corresponding to the intended recognition. In the example shown in FIG. 13, the recognition type is “Team Player”, which the recognizing entity intends as recognition that the intended recognition recipient has exhibited behavior indicative of being a good team player within a team environment (e.g., a sales team).

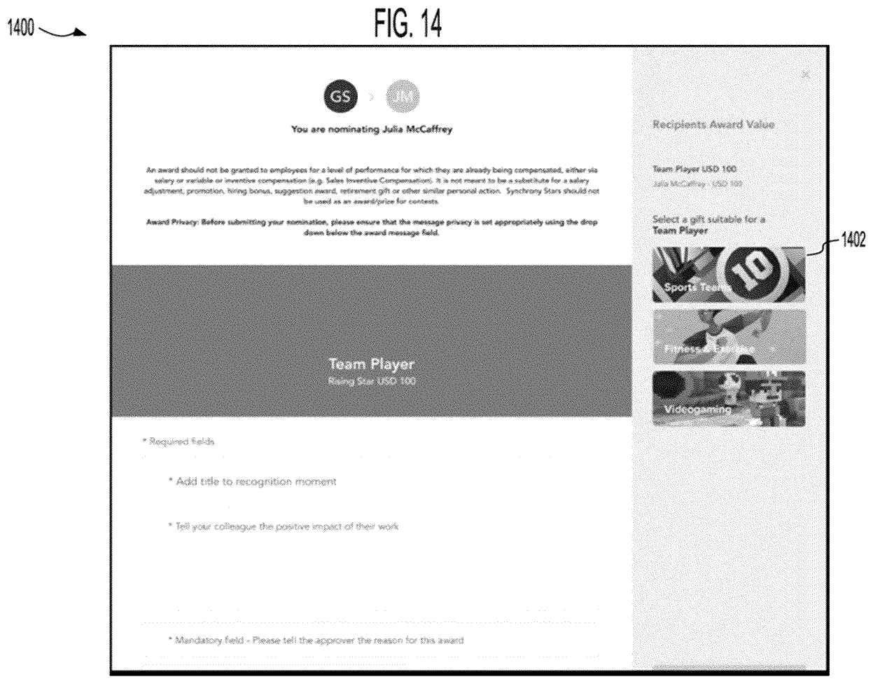

Referring to FIG. 14, FIG. 14 shows a UI portion 1400 that is similar to the UI portion 800 shown in FIG. 8, and includes a presentation of various gift option categories 1402. The gift option categories 1402 may be generated by the gift options algorithm of a gifting service system based on any user information, product information, any information related to the recognizing entity, the recognition system, etc. The gift option categories 1402 may be filtered to include only categories that include gift options that are within the recognition quantity information specified by the recognizing entity in response to the UI portion 1300 shown in FIG. 13, and that correspond to the recognition type 1302 specified by the recognizing entity (e.g., ‘Team Player’). As such, the gift option categories 1402 shown in FIG. 14 include gift option categories related to sports teams, fitness & exercise, and videogaming, all of which the gift options algorithm of the gifting service system associates with a Team Player recognition type.

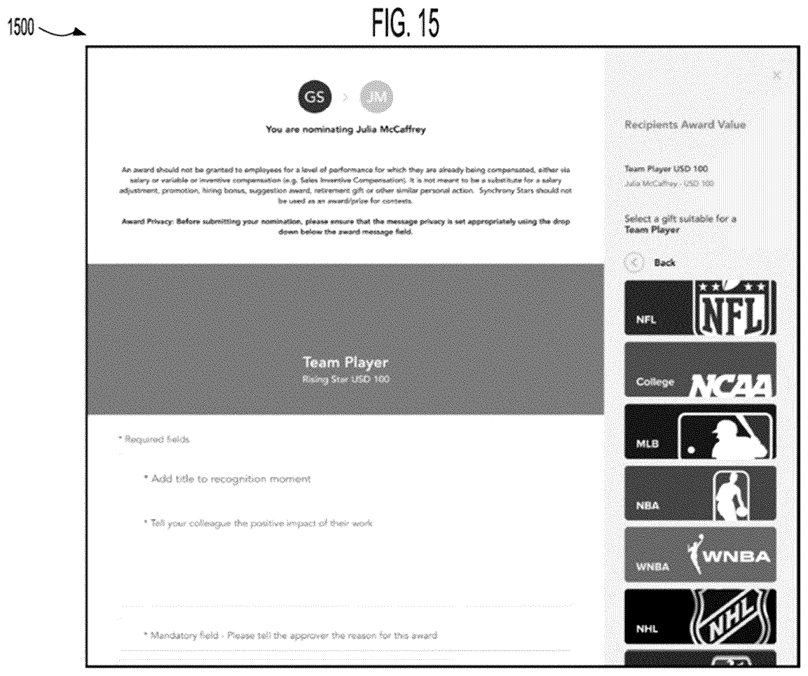

Referring to FIG. 15, FIG. 15 shows a UI portion 1500 that may be presented to a recognizing entity after the recognizing entity has selected from among the gift option categories 1402 of FIG. 14. In this scenario, the recognizing entity selected the gift option category ‘Sports Teams’. Thus, in response, the UI portion 1500 includes a request for an additional selection from the recognizing entity of a particular league of sports teams. Though not shown in FIG. 15, the UI of the recognizing entity may receive a selection of a sports league and further present a selection of sports teams from within that league, and the recognizing entity may select a particular one or more sports teams. Based on the selection of a ports team by the recognizing entity, the recognition system may present any number of gift options to the intended recognition recipient that are related to the sports team and that are within the recognition quantity amount specified in the recognition quantity information provided by the recognizing entity.

In one or more embodiments, the intended recognition recipient may be alerted that a recognition award has been given to the intended recognition recipient. The intended recognition recipient may, in response to the alert, access the UI of the recognition system and be presented with the gift option selected by the recognizing entity (e.g., a set of gift options related to a particular sports team), as well as any alternate gift options and/or alternate redemption options (e.g., donation, regift, bank recognition quantity amount for future use, etc.). The recognition recipient may then begin the gift redemption process to interact with the gifting service system and initiate a recognition redemption action set to be performed by the gifting service system.

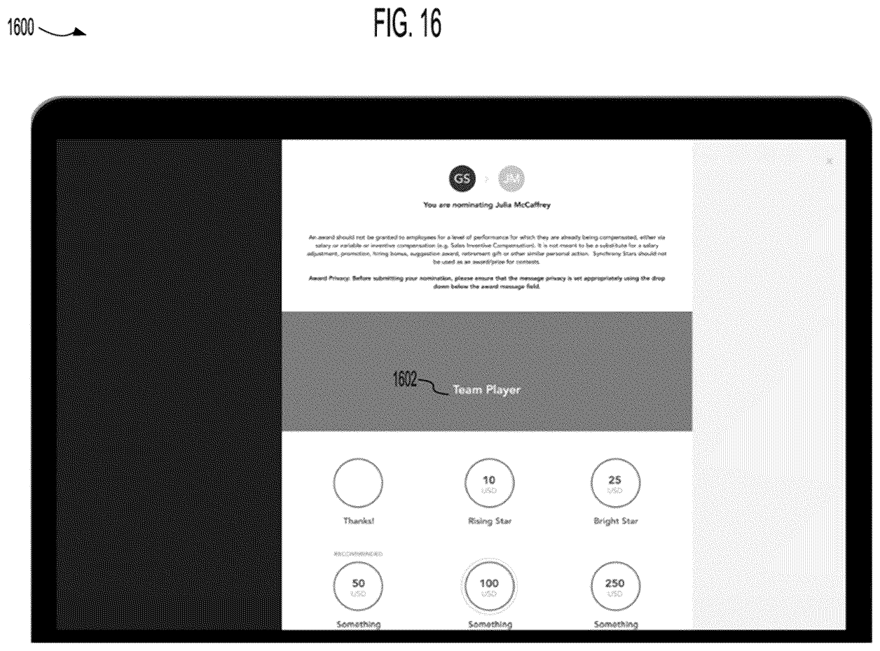

Referring to FIG. 16, FIG. 16 shows a UI portion 1600 that is similar to the UI portion 300 shown in FIG. 3, the UI portion 700 shown in FIG. 7, the UI portion 1000 shown in FIG. 10, and the UI portion 1300 shown in FIG. 13 in which a recognizing entity has selected to provide a recognition recipient (i.e., Julia McCaffrey) with a recognition award, and provides the recognizing entity the option to select the recognition quantity amount. The UI portion 1300 differs from the aforementioned UI portions (e.g., 300, 700, 1000) in that the recognizing entity, on a prior UI portion, has selected a recognition type 1602 corresponding to the intended recognition. In the example shown in FIG. 16, the recognition type is “Team Player”, which the recognizing entity intends as recognition that the intended recognition recipient has exhibited behavior indicative of being a good team player within a team environment (e.g., a sales team).

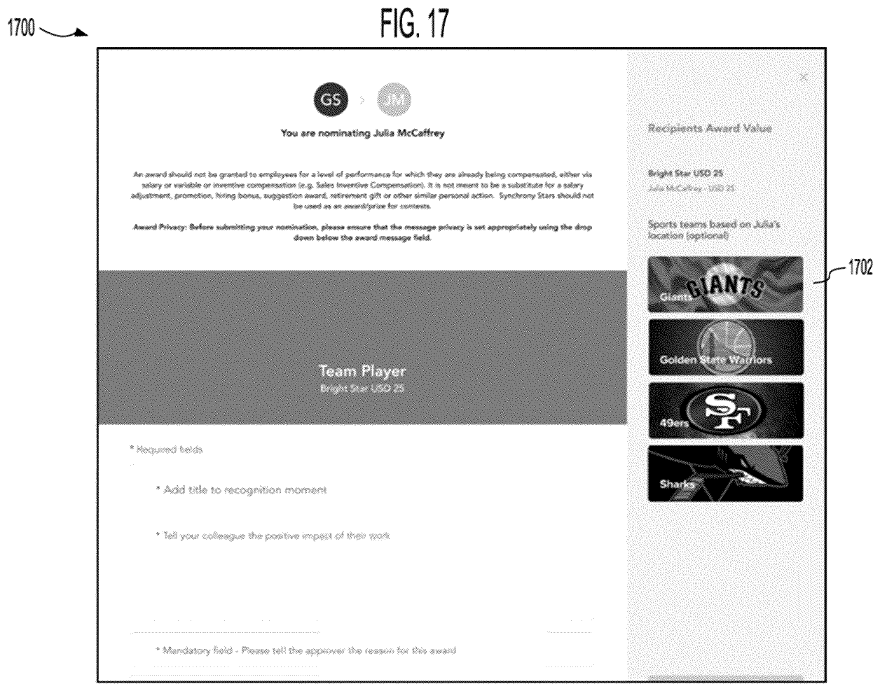

Referring to FIG. 17, FIG. 17 shows a UI portion 1700 that is similar to the UI portion 1400 shown in FIG. 14, and includes a presentation of various gift option categories 1702. The gift option categories 1702 may be generated by the gift options algorithm of a gifting service system based on any user information, product information, any information related to the recognizing entity, the recognition system, etc. The gift option categories 1702 may be filtered to include only categories that include gift options that are within the recognition quantity information specified by the recognizing entity in response to the UI portion 1600 shown in FIG. 16, that correspond to the recognition type specified by the recognizing entity (e.g., ‘Team Player’), and that are based at least in part on a location of the intended recognition recipient (e.g., as determined by the gift options algorithm based on user information related to the intended recognition recipient). As such, the gift option categories 1702 shown in FIG. 17 include gift option categories related to sports teams that are near the location (the San Francisco area in this example) of the intended recognition recipient.

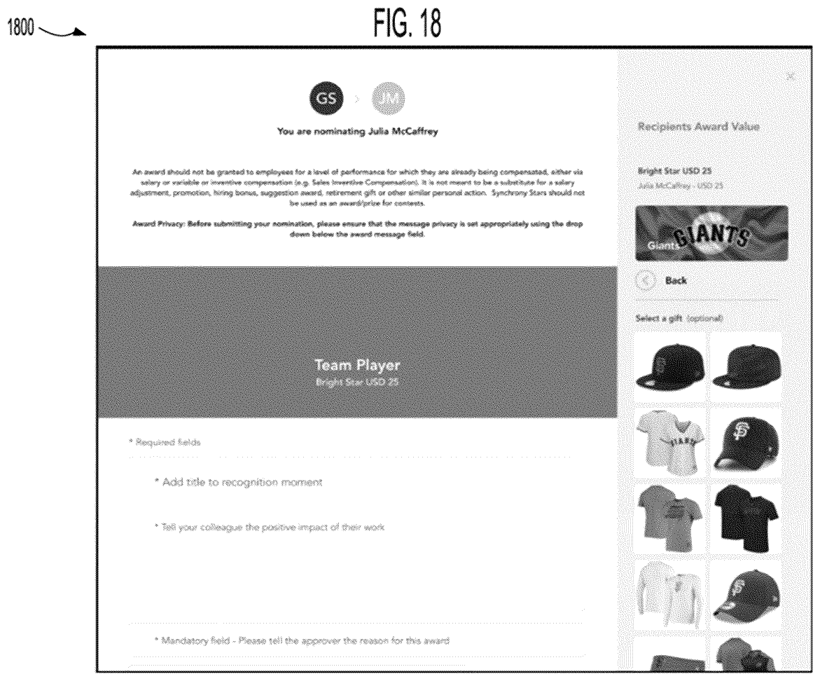

Referring to FIG. 18, FIG. 18 shows a UI portion 1800 that may be presented to a recognizing entity after the recognizing entity has selected from among the gift option categories 1702 of FIG. 17. In this scenario, the recognizing entity selected the gift option category ‘Giants’. Thus, in response, the UI portion 1800 includes a request for an additional selection from the recognizing entity of a particular one or more gifts related to the selected sports team.

In one or more embodiments, the intended recognition recipient may be alerted that a recognition award has been given to the intended recognition recipient. The intended recognition recipient may, in response to the alert, access the UI of the recognition system and be presented with the gift option selected by the recognizing entity (e.g., a set of gift options related to a particular sports team), as well as any alternate gift options and/or alternate redemption options (e.g., donation, regift, bank recognition quantity amount for future use, etc.). The recognition recipient may then begin the gift redemption process to interact with the gifting service system and initiate a recognition redemption action set to be performed by the gifting service system.

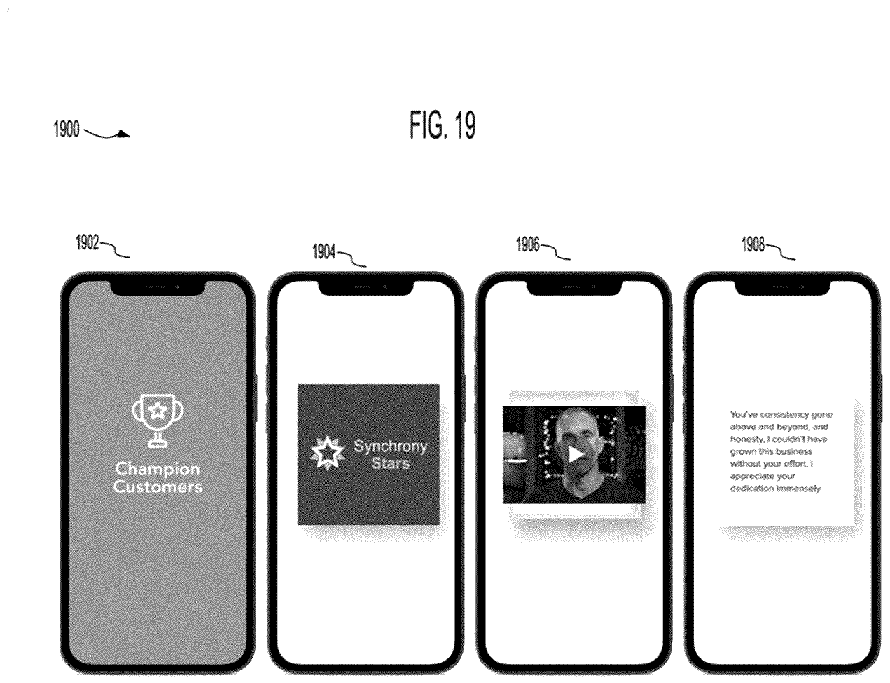

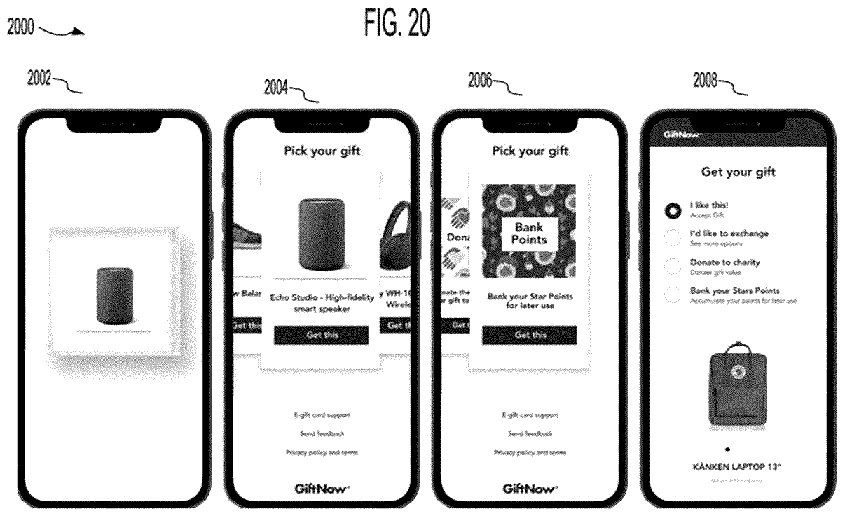

FIG. 19 and FIG. 20 show illustrative examples of a UI flow from the perspective of an intended recognition recipient in accordance with one or more embodiments described herein. The following examples are for explanatory purposes only and not intended to limit the scope of embodiments described herein. Additionally, while the examples show certain aspects of embodiments described herein, all possible aspects of such embodiments may not be illustrated in these particular examples. These examples are intended to be simple examples to illustrate, at least in part, concepts described herein.

Referring to FIG. 19, FIG. 19 illustrates an example of a series of UI portions 1900 presented to an intended recognition recipient accessing a recognition system using a mobile device. The series of UI portions 1900 include a recognition type 1902 (e.g., recognition for being a Champion Customer), an identification of the recognition system 1904, a video related to the recognition 1906, and a text notice 1908 indicating to an intended recognition recipient the reasons for the recognition award.

Referring to FIG. 20, FIG. 20 illustrates an example of a series of UI portions 2000 presented to an intended recognition recipient after the intended recognition recipient has elected to begin the recognition redemption process. As shown in FIG. 20, the UI portion 2002 shows a gift option. The gift option was selected by the recognizing entity from among a set of gift options that were within the recognition quantity amount specified as part of the recognition quantity information provided by the recognizing entity. The UI portion 2004 includes the gift option shown in the UI portion 2002, and also includes the ability to allow the intended recognition recipient to scroll left or right to see alternate gift options and/or alternate redemption options. The UI portion 2006 shows the UI portion that appears when the intended recognition recipient has scrolled past the various gift options and alternate gift options, and is within the alternate redemption options (e.g., donate the gift, bank the star points). The UI portion 2008 shows a UI portion that allows the intended recognition recipient a slightly different interface for selecting from among the gift option, the alternate gift options (e.g., exchange the gift) and the alternate redemption options (e.g., donate to charity, bank the stars points).

In one or more embodiments, once the intended recognition recipient has selected a gift option, an alternate gift option, and/or an alternate redemption option, the gifting service system may present any number of additional information requests based on the selection. As an example, if the intended recognition recipient selects to receive a gift (either the gift selected by the recognizing entity or an alternate gift option) gifting service system may request information related to the delivery of the gift to the recognition recipient. As another example, if the recognition recipient elects to donate the value of the recognition award, the gifting service system may request that the recognition recipient identify one or more donation recipients.

FIG. 21 illustrates a computing system architecture 2100, including various components in electrical communication with each other, in accordance with some embodiments. The example computing system architecture 2100 illustrated in FIG. 21 includes a computing device 2102, which has various components in electrical communication with each other using a connection 2106, such as a bus, in accordance with some implementations. The example computing system architecture 2100 includes a processing unit 2104 that is in electrical communication with various system components, using the connection 2106, and including the system memory 2114. In some embodiments, the system memory 2114 includes read-only memory (ROM), random-access memory (RAM), and other such memory technologies including, but not limited to, those described herein. In some embodiments, the example computing system architecture 2100 includes a cache 2108 of high-speed memory connected directly with, in close proximity to, or integrated as part of the processor 2104. The system architecture 2100 can copy data from the memory 2114 and/or the storage device 2110 to the cache 2108 for quick access by the processor 2104. In this way, the cache 2108 can provide a performance boost that decreases or eliminates processor delays in the processor 2104 due to waiting for data. Using modules, methods and services such as those described herein, the processor 2104 can be configured to perform various actions. In some embodiments, the cache 2108 may include multiple types of cache including, for example, level one (L1) and level two (L2) cache. The memory 2114 may be referred to herein as system memory or computer system memory. The memory 2114 may include, at various times, elements of an operating system, one or more applications, data associated with the operating system or the one or more applications, or other such data associated with the computing device 2102.

Other system memory 2114 can be available for use as well. The memory 2114 can include multiple different types of memory with different performance characteristics. The processor 2104 can include any general purpose processor and one or more hardware or software services, such as service 2112 stored in storage device 2110, configured to control the processor 2104 as well as a special-purpose processor where software instructions are incorporated into the actual processor design. The processor 2104 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 2104 can be a microprocessor, a microcontroller, a digital signal processor (“DSP”), or a combination of these and/or other types of processors. In some embodiments, the processor 2104 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 2100, an input device 2116 can represent any number of input mechanisms, such as a microphone for speech, a touch-sensitive screen for gesture or graphical input, keyboard, mouse, motion input, pen, and other such input devices. An output device 2118 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 2100. In some embodiments, the input device 2116 and/or the output device 2118 can be coupled to the computing device 2102 using a remote connection device such as, for example, a communication interface such as the network interface 2120 described herein. In such embodiments, the communication interface can govern and manage the input and output received from the attached input device 2116 and/or output device 2118. As may be contemplated, there is no restriction on operating on any particular hardware arrangement and accordingly the basic features here may be substituted for other hardware, software, or firmware arrangements as they are developed.

In some embodiments, the storage device 2110 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 2110 can include hardware and/or software services such as service 2112 that can control or configure the processor 2104 to perform one or more functions including, but not limited to, the methods, processes, functions, systems, and services described herein in various embodiments. In some embodiments, the hardware or software services can be implemented as modules. As illustrated in example computing system architecture 2100, the storage device 2110 can be connected to other parts of the computing device 2102 using the system connection 2106. In an embodiment, a hardware service or hardware module such as service 2112, that performs a function can include a software component stored in a non-transitory computer-readable medium that, in connection with the necessary hardware components, such as the processor 2104, connection 2106, cache 2108, storage device 2110, memory 2114, input device 2116, output device 2118, and so forth, can carry out the functions such as those described herein.

The disclosed gifting service system and the associated systems and methods for providing a recognition system with a technique for providing gift options to a recognition recipient may be performed using a computing system such as the example computing system illustrated in FIG. 21, using one or more components of the example computing system architecture 2100. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems described herein by, for example, executing code using a processor such as processor 2104 wherein the code is stored in memory such as memory 2114 as described herein. One or more of a user device, a provider server or system, a database system, or other such devices, services, or systems may include some or all of the components of the computing system such as the example computing system illustrated in FIG. 21, using one or more components of the example computing system architecture 2100 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 2128. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 2104 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 2114 can be coupled to the processor 2104 by, for example, a connector such as connector 2106, or a bus. As used herein, a connector or bus such as connector 2106 is a communications system that transfers data between components within the computing device 2102 and may, in some embodiments, be used to transfer data between computing devices. The connector 2106 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 2114 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 2114 can also include magnetic or optical data storage media including read-only (e.g., CD ROM and DVD ROM) or otherwise (e.g., CD or DVD). The memory can be local, remote, or distributed.

As described herein, the connector 2106 (or bus) can also couple the processor 2104 to the storage device 2110, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 2110. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 2106 can also couple the processor 2104 to a network interface device such as the network interface 2120. The interface can include one or more of a modem, network interface card (NIC), or other such network interfaces including, but not limited to those described herein. It will be appreciated that the network interface 2120 may be considered to be part of the computing device 2102 or may be separate from the computing device 2102. The network interface 2120 can include one or more of an analog modem, Integrated Services Digital Network (ISDN) modem, cable modem, token ring interface, satellite transmission interface, or other interfaces for coupling a computer system to other computer systems. In some embodiments, the network interface 2120 can include one or more input and/or output (I/O) devices. The I/O devices can include, by way of example but not limitation, input devices such as input device 2116 and/or output devices such as output device 2118. For example, the network interface 2120 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, cCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 2102 can be connected to one or more additional computing devices such as computing device 2124 via a network 2122 using a connection such as the network interface 2120. In such embodiments, the computing device 2124 may execute one or more services 2126 to perform one or more functions under the control of, or on behalf of, programs and/or services operating on computing device 2102. In some embodiments, a computing device such as computing device 2124 may include one or more of the types of components as described in connection with computing device 2102 including, but not limited to, a processor such as processor 2104, a connection such as connection 2106, a cache such as cache 2108, a storage device such as storage device 2110, memory such as memory 2114, an input device such as input device 2116, and an output device such as output device 2118. In such embodiments, the computing device 2124 can carry out the functions such as those described herein in connection with computing device 2102. In some embodiments, the computing device 2102 can be connected to a plurality of computing devices such as computing device 2124, each of which may also be connected to a plurality of computing devices such as computing device 2124. Such an embodiment may be referred to herein as a distributed computing environment.

The network 2122 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 2122 can be wired connections, wireless connections, or combinations thereof. Communications via the network 2122 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 2122, within the computing device 2102, within the computing device 2124, or within the computing resources provider 2128 can include information, which also may be referred to herein as content. The information may include text, graphics, audio, video, haptics, and/or any other information that can be provided to a user of the computing device such as the computing device 2102. In an embodiment, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 2102 and presented to a user of the computing device 2102 using forms that are perceptible via sight, sound, smell, taste, touch, or other such mechanisms. In some embodiments, communications over the network 2122 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 2102 and/or the computing device 2124 can be connected to a computing resources provider 2128 via the network 2122 using a network interface such as those described herein (e.g. network interface 2120). In such embodiments, one or more systems (e.g., service 2130 and service 2132) hosted within the computing resources provider 2128 (also referred to herein as within “a computing resources provider environment”) may execute one or more services to perform one or more functions under the control of, or on behalf of, programs and/or services operating on computing device 2102 and/or computing device 2124. Systems such as service 2130 and service 2132 may include one or more computing devices such as those described herein to execute computer code to perform the one or more functions under the control of, or on behalf of, programs and/or services operating on computing device 2102 and/or computing device 2124.

For example, the computing resources provider 2128 may provide a service, operating on service 2130 to store data for the computing device 2102 when, for example, the amount of data that the computing device 2102 attempts to store exceeds the capacity of storage device 2110. In another example, the computing resources provider 2128 may provide a service to first instantiate a virtual machine (VM) on service 1132, use that VM to access the data stored on service 2132, perform one or more operations on that data, and provide a result of those one or more operations to the computing device 2102. Such operations (e.g., data storage and VM instantiation) may be referred to herein as operating “in the cloud,” “within a cloud computing environment,” or “within a hosted virtual machine environment,” and the computing resources provider 2128 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 2128 include, but are not limited to, data analytics, data storage, archival storage, big data storage, virtual computing (including various scalable VM architectures), blockchain services, containers (e.g., application encapsulation), database services, development environments (including sandbox development environments), c-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 2130 and service 2132 may implement versions of various services (e.g., the service 2112 or the service 2126) on behalf of, or under the control of, computing device 2102 and/or computing device 2124. Such implemented versions of various services may involve one or more virtualization techniques so that, for example, it may appear to a user of computing device 2102 that the service 2112 is executing on the computing device 2102 when the service is executing on, for example, service 2130. As may also be contemplated, the various services operating within the computing resources provider 2128 environment may be distributed among various systems within the environment as well as partially distributed onto computing device 2124 and/or computing device 2102.

In an embodiment, the computing device 2102 can be connected to one or more additional computing devices and/or services such as merchant computing device 2136 and/or a point-of-sale service 2134 via the network 2122 and using a connection such as the network interface 2120. In an embodiment, the point-of-sale service 2134 is separate from the merchant computing device 2136. In an embodiment, the point-of-sale service 2134 is executing on the merchant computing device 2136. In an embodiment, the point-of-sale service 2134 is executing as one or more services (e.g., the service 2130 and/or the service 2132) operating within the environment of the computing resources provider. As used herein, a point-of-sale service 2134 is a service used by one or more merchants to manage sales transactions for customers, to process payment transactions for customers (e.g., credit card transactions), to manage inventory for merchants, to identify customers based on, for example, customer loyalty programs, and other such tasks.

In an embodiment, a customer and/or a merchant uses the merchant computing device 2136 to interact with the point-of-sale service 2134. In an embodiment, the merchant computing device 2136 is a dedicated point-of-service (POS) terminal. In an embodiment, the merchant computing device 2136 is a cash register system. In an embodiment, the merchant computing device 2136 is an application or web service operating on a computing device such as the computing device 2102 described herein. In such an embodiment, the application or web service may be provided by a financial services system (e.g., a bank, a transaction processing system, an inventory management system, or some other such financial services system). In an embodiment, the merchant computing device 2136 includes an auxiliary device or system to execute tasks associated with the point-of-sale service 2134 (e.g., a credit card processing device attached to a smart phone or tablet). In an embodiment, the merchant computing device 2136 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor or retailer. In an embodiment, the merchant computing device 2136 is a virtual device (e.g., a virtual kiosk) such as the virtual devices described herein. Although not illustrated here, in an embodiment, the merchant computing device 2136 may be one of a plurality of devices that may be interconnected using a network such as the network 2122.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to store data temporarily or permanently. A network interface, such as a wireless or wired interface, can enable the computing device to communicate with a network. Examples of computing devices (e.g., the computing device 2102) include, but are not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computing device 2102.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to illustrate embodiments more clearly and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use

Aspects described herein include, but are not limited to:

Clause 1. A computer-implemented method, comprising: receiving a recognition initiation request, wherein the recognition initiation request includes recognition quantity information and additional recognition information; determining gift option information using a gift options algorithm; providing the gift option information in response to the recognition initiation request; receiving gift selection information; providing recognition gift options based on the gift selection information; receiving recognition redemption information in response to the recognition gift options; and performing a recognition redemption action set using the recognition redemption information.

Clause 2. The computer-implemented method of clause 1, wherein the gift option information is based at least in part on the recognition quantity information.

Clause 3. The computer-implemented method of clause 1, wherein the gift option information includes a plurality of gift choices, and the gift selection information includes a selection of a portion of the plurality of gift choices.

Clause 4. The computer-implemented method of clause 1, wherein the gift option information includes a plurality of gift categories, and the gift selection information includes a selection of a gift category of the plurality of gift categories.

Clause 5. The computer-implemented method of clause 1, wherein the additional recognition information includes a recognition type, and the gift option information is based at least in part on the recognition type.

Clause 6. The computer-implemented method of clause 1, wherein the additional recognition information includes recognition recipient information associated with a recognition recipient, and the gift option information is based at least in part on the recognition recipient information.

Clause 7. The computer-implemented method of clause 1, wherein the additional recognition information includes recognition recipient information associated with a recognition recipient, and wherein the recognition recipient information is obtained using a real-time interactive interface.

Clause 8. The computer-implemented method of clause 1, wherein the gift option information is based on the recognition initiation request and temporal information.

Clause 9. The computer-implemented method of clause 1, wherein the gift option information is based on the recognition initiation request and geographic information.

Clause 10. The computer-implemented method of clause 1, wherein the recognition gift options include a donation option and the recognition redemption action set includes providing a donation to a donation recipient.

Clause 11. The computer-implemented method of clause 1, wherein the recognition gift options include a stored value accumulation option and the recognition redemption action set includes adding a stored value quantity to a value store amount associated with a recognition recipient.

Clause 12. The computer-implemented method of clause 1, wherein the recognition gift options include a plurality of different gifts.

Clause 13. The computer-implemented method of clause 1, wherein the recognition redemption information includes a gift selection and a recognition recipient identifier.

Clause 14. The computer-implemented method of clause 1, wherein the recognition redemption information includes gift customization options.

Clause 15. A system, comprising: one or more processors; and memory storing thereon instructions that, as a result of being executed by the one or more processors, cause the system to: receive a recognition initiation request, wherein the recognition initiation request includes recognition quantity information and additional recognition information; determine gift option information using a gift options algorithm; provide the gift option information in response to the recognition initiation request; receive gift selection information; provide recognition gift options based on the gift selection information; receive recognition redemption information in response to the recognition gift options; and perform a recognition redemption action set using the recognition redemption information.

Clause 16. The system of clause 15, wherein the gift option information is based at least in part on the recognition quantity information.

Clause 17. The system of clause 15, wherein the gift option information includes a plurality of gift choices, and the gift selection information includes a selection of a portion of the plurality of gift choices.

Clause 18. The system of clause 15, wherein the gift option information includes a plurality of gift categories, and the gift selection information includes a selection of a gift category of the plurality of gift categories.

Clause 19. The system of clause 15, wherein the additional recognition information includes a recognition type, and the gift option information is based at least in part on the recognition type.

Clause 20. The system of clause 15, wherein the additional recognition information includes recognition recipient information associated with a recognition recipient, and the gift option information is based at least in part on the recognition recipient information.

Clause 21. The system of clause 15, wherein the gift option information is based on the recognition initiation request and geographic information.

Clause 22. The system of clause 15, wherein the recognition gift options include a stored value accumulation option and the recognition redemption action set includes adding a stored value quantity to a value store amount associated with a recognition recipient.

Clause 23. A non-transitory, computer-readable storage medium storing thereon executable instructions that, as a result of being executed by a computer system, cause the computer system to: receive a recognition initiation request, wherein the recognition initiation request includes recognition quantity information and additional recognition information; determine gift option information using a gift options algorithm; provide the gift option information in response to the recognition initiation request; receive gift selection information; provide recognition gift options based on the gift selection information; receive recognition redemption information in response to the recognition gift options; and perform a recognition redemption action set using the recognition redemption information.

Clause 24. The non-transitory, computer-readable storage medium of clause 23, wherein the gift option information is based at least in part on the recognition quantity information.

Clause 25. The non-transitory, computer-readable storage medium of clause 23, wherein the gift option information includes a plurality of gift choices, and the gift selection information includes a selection of a portion of the plurality of gift choices.

Clause 26. The non-transitory, computer-readable storage medium of clause 23, wherein the gift option information includes a plurality of gift categories, and the gift selection information includes a selection of a gift category of the plurality of gift categories.

Clause 27. The non-transitory, computer-readable storage medium of clause 23, wherein the additional recognition information includes a recognition type, and the gift option information is based at least in part on the recognition type.

Clause 28. The non-transitory, computer-readable storage medium of clause 23, wherein the additional recognition information includes recognition recipient information associated with a recognition recipient, and the gift option information is based at least in part on the recognition recipient information.

Clause 29. The non-transitory, computer-readable storage medium of clause 23, wherein the gift option information is based on the recognition initiation request and geographic information.

Clause 30. The non-transitory, computer-readable storage medium of clause 23, wherein the recognition gift options include a stored value accumulation option and the recognition redemption action set includes adding a stored value quantity to a value store amount associated with a recognition recipient.

What is claimed is:

1. A computer-implemented method, comprising:
receiving a recognition initiation request, wherein the recognition initiation request includes recognition quantity information and additional recognition information;
determining gift option information using a gift options algorithm;
providing the gift option information in response to the recognition initiation request;
receiving gift selection information;
providing recognition gift options based on the gift selection information;
receiving recognition redemption information in response to the recognition gift options; and
performing a recognition redemption action set using the recognition redemption information.

2. The computer-implemented method of claim 1, wherein the gift option information is based at least in part on the recognition quantity information.

3. The computer-implemented method of claim 1, wherein the gift option information includes a plurality of gift choices, and the gift selection information includes a selection of a portion of the plurality of gift choices.

4. The computer-implemented method of claim 1, wherein the gift option information includes a plurality of gift categories, and the gift selection information includes a selection of a gift category of the plurality of gift categories.

5. The computer-implemented method of claim 1, wherein the additional recognition information includes a recognition type, and the gift option information is based at least in part on the recognition type.

6. The computer-implemented method of claim 1, wherein the additional recognition information includes recognition recipient information associated with a recognition recipient, and the gift option information is based at least in part on the recognition recipient information.

7. The computer-implemented method of claim 1, wherein the additional recognition information includes recognition recipient information associated with a recognition recipient, and wherein the recognition recipient information is obtained using a real-time interactive interface.

8. A system, comprising:
one or more processors; and
memory storing thereon instructions that, as a result of being executed by the one or more processors, cause the system to:
receive a recognition initiation request, wherein the recognition initiation request includes recognition quantity information and additional recognition information;
determine gift option information using a gift options algorithm;
provide the gift option information in response to the recognition initiation request;
receive gift selection information;
provide recognition gift options based on the gift selection information;
receive recognition redemption information in response to the recognition gift options; and
perform a recognition redemption action set using the recognition redemption information.

9. The system of claim 8, wherein the gift option information is based at least in part on the recognition quantity information.

10. The system of claim 8, wherein the gift option information includes a plurality of gift choices, and the gift selection information includes a selection of a portion of the plurality of gift choices.

11. The system of claim 8, wherein the gift option information includes a plurality of gift categories, and the gift selection information includes a selection of a gift category of the plurality of gift categories.

12. The system of claim 8, wherein the additional recognition information includes a recognition type, and the gift option information is based at least in part on the recognition type.

13. The system of claim 8, wherein the additional recognition information includes recognition recipient information associated with a recognition recipient, and the gift option information is based at least in part on the recognition recipient information.

14. The system of claim 8, wherein the gift option information is based on the recognition initiation request and geographic information.

15. A non-transitory, computer-readable storage medium storing thereon executable instructions that, as a result of being executed by a computer system, cause the computer system to:
receive a recognition initiation request, wherein the recognition initiation request includes recognition quantity information and additional recognition information;
determine gift option information using a gift options algorithm;
provide the gift option information in response to the recognition initiation request;
receive gift selection information;
provide recognition gift options based on the gift selection information;
receive recognition redemption information in response to the recognition gift options; and
perform a recognition redemption action set using the recognition redemption information.

16. The non-transitory, computer-readable storage medium of claim 15, wherein the gift option information is based at least in part on the recognition quantity information.

17. The non-transitory, computer-readable storage medium of claim 15, wherein the gift option information includes a plurality of gift choices, and the gift selection information includes a selection of a portion of the plurality of gift choices.

18. The non-transitory, computer-readable storage medium of claim 15, wherein the gift option information includes a plurality of gift categories, and the gift selection information includes a selection of a gift category of the plurality of gift categories.

19. The non-transitory, computer-readable storage medium of claim 15, wherein the additional recognition information includes a recognition type, and the gift option information is based at least in part on the recognition type.

20. The non-transitory, computer-readable storage medium of claim 15, wherein the additional recognition information includes recognition recipient information associated with a recognition recipient, and the gift option information is based at least in part on the recognition recipient information.
